(19) United States
(12) Patent Application Publication
(10) Pub. No.: US 2025/0286320 A1
(43) Pub. Date: Sep. 11, 2025

(54) RELIABLE HIGH-SPEED, HIGH-DENSITY CONNECTOR AND INTERCONNECTION SYSTEM THEREOF

(71) Applicant: Amphenol Commercial Products (Chengdu) Co., Ltd., Chengdu (CN)

(72) Inventors: Xiangjun He, Chengdu (CN); Chao Zou, Chengdu (CN); Yaohua Hou, Chengdu (CN)

(73) Assignee: Amphenol Commercial Products (Chengdu) Co., Ltd., Chengdu (CN)

(21) Appl. No.: 19/073,411

(22) Filed: Mar. 7, 2025

(30) Foreign Application Priority Data
Mar. 11, 2024 (CN) 202410277511.1
Mar. 11, 2024 (CN) 202420469174.1

(51) Int. Cl. H01R 13/639; H01R 12/75; H01R 13/64

(52) U.S. Cl. CPC H01R 13/639; H01R 13/64; H01R 12/75; H01R 2201/26

(57) ABSTRACT

Reliable high-speed, high-density connectors and interconnection systems thereof. An interconnection system includes a plug connector and a receptacle connector. The plug connector comprises a housing assembly, a module, and a CPA device. The module includes densely disposed conductive pads. The module can include a circuit board with the conductive pads and high-speed data cables having ends mounted onto the conductive pads. The CPA device is disposed on the housing assembly, and configured for securing the plug connector to the receptacle connector. The CPA device can include locking features disposed on different sides of the housing assembly, which can improve reliability. The receptacle connector includes an outer housing having complementary locking features. The connectors can be electrically connected as long as a first locking feature in its locked position. Such techniques can enable interconnection systems for harsh environments such as one presented by an automobile.

### CROSS-REFERENCE TO RELATED APPLICATIONS

This application claims priority to and the benefit of Chinese Patent Application No. 202420469174.1, filed on Mar. 11, 2024. This application also claims priority to and the benefit of Chinese Patent Application No. 202410277511.1, filed on Mar. 11, 2024. The contents of these applications are incorporated herein by reference in their entirety.

### TECHNICAL FIELD

The present disclosure generally to electrical electronic system, such as those including electrical connectors, used to interconnect electronic assemblies.

### BACKGROUND

Electrical connectors are used in many electronic systems. It is generally easier and more cost effective to manufacture an electronic system as separate electronic assemblies, which may be joined together with electrical connectors. Electrical connectors may be used for interconnecting assemblies so that the assemblies may operate together as part of an electronic system. Electrical connectors, for example, may be mounted onto printed circuit boards within two assemblies that are connected by mating the electrical connectors. In other electronic systems, it may be impractical to join two printed circuit boards by directly mating electrical connectors on these printed circuit boards. For example, these printed circuit boards may be spaced so far apart in assembled electronic systems that the electrical connectors mounted in the boards cannot be directly connected.

In the electronic systems, assemblies may be interconnected through cables. The cables may be terminated with connectors that can mate with connectors mounted on printed circuit boards. In this way, the assemblies may be interconnected by plugging electrical connectors that are part of cable assemblies into electrical connectors mounted onto printed circuit boards. In other electronic system architectures, an electrical connector terminated to a cable may be mated with another electrical connector terminated to another cable.

Modern automobiles are examples of electronic systems with assemblies connected through cables. For example, the automobiles may include electronic control units (ECUs) for controlling various automotive systems, such as engines, transmission control units (TCUs), security systems, emission control, lighting, advanced driver assistance systems (ADASs), entertainment systems, navigation systems and cameras. The ECUs may be manufactured as separate assemblies that are connected by one or more cables routed between the assemblies. To simplify manufacturing, an assembly may include one or more cables terminated with an electrical connector, which can be mated to another electrical connector terminated to other cables or attached to a circuit board within another assembly.

### SUMMARY

Aspects of the present disclosure relate to reliable high-speed, high-density connectors and interconnection systems thereof.

Some embodiments relate to an electrical connector. The electrical connector may include a housing assembly; a module held by the housing assembly and comprising a plurality of conductive pads along a mating edge disposed in a pitch less than or equal to 1.0 mm and a plurality of conductors extending away from the mating edge; and a connector position assurance (CPA) device coupled to the housing assembly and configured for securing the electrical connector to a mating electrical connector.

Optionally, the plurality of conductive pads are a plurality of first conductive pads configured for signal transmission; and the module comprises a second conductive pad configured for power transmission.

Optionally, the module may comprise a circuit board disposed inside the housing assembly and comprising the plurality of first conductive pads and the second conductive pad, each of the plurality of first conductive pads having a front end configured to contact a mating electrical connector and a rear end, the second conductive pad having a front end configured to contact the mating electrical connector and a rear end; a plurality of first cables comprising first wires disposed in a first pitch less than or equal to 1.0 mm, the first wires having ends mounted to the rear ends of the plurality of first conductive pads of the circuit board so as to electrically connect to the plurality of conductive pads; and a plurality of second cables comprising second wires disposed in a second pitch greater than the first pitch, the second wires comprising ends mounted to the rear end of the second conductive pad.

Optionally, the plurality of conductive pads conform to Peripheral Component Interconnect Express Generation 5 and/or Generation 6 for transmission rates.

Optionally, the CPA device comprises a first locking feature having a first locked position and a first unlocked position, and a second locking feature having a second locked position and a second unlocked position; the first locking feature and the second locking feature are disposed on different sides of the housing assembly; and the first locking feature is configured to be movable from the first locked position to the first unlocked position when the second locking feature is in the first unlocked position and to remain in the first locked position when the second locking feature is in the second locked position.

Optionally, the CPA device comprises a third locking features having a third locked position and a third unlocked position; and the third locking feature is coupled to the second locking feature such that the second locking feature is in the second locked position when the third locking feature is in the third locked position and the second locking feature is in the second unlocked position when the third locking feature is in the third unlocked position.

Optionally, the first locking feature comprises a spring biased element; and the second locking feature comprises a pull tab.

Some embodiments relate to an electrical connector. The electrical connector may include a housing assembly; a module held by the housing assembly and comprising a plurality of conductive pads; and a connector position assurance (CPA) device coupled to the housing assembly and configured for securing the electrical connector to a mating electrical connector, the CPA device comprising first and second locking features disposed on different sides of the housing assembly.

Optionally, the CPA device comprises a first locking feature having a first locked position and a first unlocked position, and a second locking feature having a second locked position and a second unlocked position; and the first locking feature is configured to be movable from the first locked position to the first unlocked position when the second locking feature is in the first unlocked position and to remain in the first locked position when the second locking feature is in the second locked position.

Optionally, the CPA device comprises a third locking features having a third locked position and a third unlocked position; and the third locking feature is coupled to the second locking feature such that the second locking feature is in the second locked position when the third locking feature is in the third locked position and the second locking feature is in the second unlocked position when the third locking feature is in the third unlocked position.

Optionally, the CPA device comprises a first operating member configured to be operable in a mating direction so as to move the first locking feature between the first locked position and the first unlocked position; and a second operating member configured to be operable in a direction perpendicular to the mating direction so as to move the second locking feature between the second locked position and the second unlocked position.

Optionally, the third locking feature is configured to engage the first operating member when the third locking feature is in the third locked position so as to restrain movement of the first operating member, and disengage the first operating member when the third locked feature is in the third unlocked position.

Optionally, the first locking feature comprises a first locking head configured to engage a first side of the mating electrical connector; a first tail configured to engage the first operating member; and an intermediate portion joining the first locking head and the first tail and pivotably connected to the housing assembly about a first axis such that the first locking feature is pivotable between the first locked position and the first unlocked position.

Optionally, the first locking feature comprises a resilient beam configured to abut the housing assembly so as to bias the first locking head toward outside of the housing assembly; and the electrical connector comprises a resilient member disposed between the second locking feature and the housing assembly and configured to bias the second locking feature toward the second locked position.

Optionally, the second operating member is configured to engage a second side of the mating electrical connector; and the second operating member comprises the first locking feature, the second locking feature, and an intermediate portion joining the first locking feature and the second locking feature and pivotably connected to the housing assembly about a second axis perpendicular to the first axis.

Optionally, the plurality of conductive pads are dimensioned to be in electrical contact with the mating electrical connector as long as the first locking feature is in the first locked position.

Some embodiments relate to an electrical connector. The electrical connector may include a main housing comprising a mating portion for engaging a mating electrical connector; a plurality of conductive terminals held by the main housing; a cage disposed outside the main housing and comprising a front portion extending beyond the mating portion; and an outer housing attached to the front portion of the cage, the outer housing comprising first and second locking features configured to engage complementary locking features of the mating electrical connector, the first locking feature disposed on a first side of the outer housing and the second locking feature disposed on a second side of the outer housing.

Optionally, the cage comprises a barb protruding outwardly; and the outer housing comprises an opening for engaging the barb.

Optionally, the outer housing comprises a locking portion extending beyond the front portion of the cage, the locking portion comprising the first and second locking features; the locking portion of the outer housing comprises first walls opposite each other and a second wall joining the first walls, the second wall comprising a bulge protruding outwardly; the first locking feature comprises first openings extending through the first walls; and the second locking feature comprises a second opening extending through the bulge.

Optionally, the main housing comprises a slot configured to receive a substrate comprising a plurality of conductive pads disposed in a pitch less than or equal to 1.0 mm.

Some embodiments relate to an automotive wiring harness. The automotive wiring harness may include the electrical connector described herein.

Some embodiments relate to an electrical connector. The electrical connector may comprise a housing assembly, a circuit board, a plurality of high-speed data cables, and a connector position assurance (CPA) device. The circuit board may be disposed inside the housing assembly, and include a plurality of conductive pads for electrical contact with a mating electrical connector. The plurality of high-speed data cables may have ends mounted onto the circuit board and electrically connected to the plurality of conductive pads. The CPA device may be disposed on the housing assembly, and configured for locking the electrical connector to the mating electrical connector.

Optionally, the plurality of high-speed data cables may conform to Peripheral Component Interconnect Express Generation 5 and/or Generation 6 for transmission rates.

Optionally, a pitch between adjacent high-speed data cables of the plurality of high-speed data cables may be less than or equal to 1.0 mm.

Optionally, the CPA device may include a first locking feature and a second locking feature. The first locking feature may have a first locked position to lock the mating electrical connector and a first unlocked position to release the mating electrical connector. The second locking feature may have a second locked position to lock the mating electrical connector and a second unlocked position to release the mating electrical connector. The first locking feature and the second locking feature may be configured for locking different sides of the mating electrical connector, respectively.

Optionally, the CPA device may further include a first operating member and a third locking feature. The first operating member may be operable along a predetermined direction. The first locking feature may be movable from the first locked position to the first unlocked position based on the operation of the first operating member. The third locking feature may have a third locking position and a third unlocked position. The third locking feature may be configured to lock the first operating member when in the third locked position such that the first locking feature is retained in the first locked position; and the third locking feature may be further configured to release the first operating member when in the third unlocked position such that the first operating member is operable.

Optionally, the CPA device may include a first operating member, a first locking feature, and a third locking feature. The first operating member may be operable along a predetermined direction. The first locking feature may have a first locked position to lock the mating electrical connector and a first unlocked position to release the mating electrical connector. The first locking feature may be movable from the first locked position to the first unlocked position based on the operation of the first operating member. The third locking feature may have a third locking position and a third unlocked position. The third locking feature may be configured to lock the first operating member when in the third locked position such that the first locking feature is retained in the first locked position; and the third locking feature may be further configured to release the first operating member when in the third unlocked position such that the first operating member is operable.

Optionally, the CPA device may further include a second locking feature, having a second locked position to lock the mating electrical connector and a second unlocked position to release the mating electrical connector. The first locking feature and the second locking feature may be configured for locking different sides of the mating electrical connector, respectively.

Optionally, the first locking feature may include a first locking head for locking with the mating electrical connector, a first tail for coupling to the first operating member, and an intermediate portion joining the first locking head and the first tail. The intermediate portion may be pivotably connected to the housing assembly about a first predetermined axis such that the first locking feature is pivotable between the first locked position and the first unlocked position. When the first locking feature is moved from the first locked position to the first unlocked position, the first locking head may be pivoted toward the inside of the housing assembly.

Optionally, the first locking feature may include a resilient beam bent toward the inside of the housing assembly, and the resilient beam may abut against the housing assembly so that the first locking head is biased toward the outside of the housing assembly.

Optionally, the first operating member may be configured to be returnable to an initial position for locking with the third locking feature under the bias of the resilient beam.

Optionally, the first tail may have a V-shaped slot with an opening facing the inside of the housing assembly. The first operating member may be slidable along a sidewall of the V-shaped slot such that the first locking feature is pivotable between the first locked position and the first unlocked position.

Optionally, an end of the first tail may abut against the housing assembly when the first locking feature is in the first locked position.

Optionally, the CPA device may further include a second operating member. An intermediate portion of the second operating member may be pivotably connected to the housing assembly about a second predetermined axis, and the second locking feature and the third locking feature may be located at opposite ends of the second operating member, respectively. When the second locking feature is in the second locked position, the third locking feature may be in the third locked position; and when the second locking feature is in the second unlocked position, the third locking feature may be in the third unlocked position.

Optionally, the predetermined direction may be perpendicular to the second predetermined axis.

Optionally, when the second locking feature is in the second unlocked position, the electrical connector is able to be partially mated/unmated from the mating electrical connector. The electrical connector may be completely detached from the mating electrical connector based on the operation of the first operating member.

Optionally, the second locking feature may be retained in the second unlocked position under the action of the mating electrical connector during the partial mating/unmating of the electrical connector.

Optionally, the plurality of conductive pads of the circuit board may be dimensioned to be in electrical contact with the mating electrical connector during the partial mating/unmating of the electrical connector.

Optionally, the housing assembly may comprise a first housing and a second housing fixed onto the first housing, and the first locking feature and the first operating member may be mounted between the first housing and the second housing.

Optionally, the first locking feature may be pivotably connected between the first housing and the second housing through a first shaft. The first shaft may pass through the first locking feature, and two ends of the first shaft may be fixed to the first housing and the second housing, respectively, such that the first housing and the second housing are connected to each other.

Optionally, there may be a pair(s) of the first locking features. Each pair of the first locking features may be disposed on two sides of the first housing and the second housing opposite each other along a first lateral direction perpendicular to the predetermined direction. The first locking features each may be mounted between the first housing and the second housing through a respective first shaft.

Optionally, the first housing may include a first mating portion and a first cable connection portion. The first mating portion may be configured for mating with the mating electrical connector and include a first mounting channel for accommodating the circuit board. The second housing may be fastened onto the first cable connection portion to form a second mounting channel with the first cable connection portion. The plurality of high-speed data cables may pass through the second mounting channel. The first operating member may be slidably connected to the second mounting channel along the predetermined direction by the first housing and the second housing.

Optionally, the first mating portion and the first cable connection portion may be disposed opposite each other along the predetermined direction.

Optionally, the housing assembly may further comprise a third housing fastened onto the second housing. The second operating member may be mounted between the second housing and the third housing. The second locking feature may pass through the second housing and protrudes beyond an outer surface of the second housing. The third locking feature may be located inside the third housing.

Optionally, second shafts may be provided on two sides of the intermediate portion of the second operating member, respectively. Holes may be encircled by the second housing and the third housing. The second shafts may be inserted into the holes, respectively.

Optionally, the second operating member may include a second operating portion passing through the second housing and located between the second shaft and the second locking feature.

Optionally, the housing assembly may further comprise a strain relief member, connected to the second housing and spaced apart from the first shaft along the predetermined direction. A portion of the first housing may be clamped between the second housing and the strain relief member.

Optionally, the second housing may be embedded with a nut. A fastener may pass through the strain relief member and be threaded to the nut to secure the strain relief member to the second housing.

Optionally, a resilient member may be provided between the second operating member and the housing assembly, for biasing the second locking feature toward the second locked position.

Optionally, the housing assembly may include a first slot and a second slot extending along the predetermined direction, and a first operating portion. The first slot and the second slot may be spaced apart along a first lateral direction perpendicular to the predetermined direction. The first operating member may include a first arm and a second arm, movably inserted into the first slot and the second slot, respectively. One end of the first arm and that of the second arm may be coupled to the first locking feature such that the first locking feature is movable between the first locked position and the first unlocked position. The first operating portion may be connected between the other end of the first arm and that of the second arm, and protrude beyond the housing assembly.

Optionally, the first operating member may further include a crossbeam connected between the middle portions of first arm and the second arm, and the third locking feature may be hooked onto the crossbeam when in the third locked position.

Optionally, the housing assembly may include an opening, and the crossbeam may pass through the opening to limit a sliding range of the first operating member.

Optionally, the predetermined direction may be a mating direction of the electrical connector to the mating electrical connector.

Some embodiments relate to a connector position assurance (CPA) device. The CPA device may comprise a first locking feature and a second locking feature. The first locking feature may have a first locked position to lock a mating electrical connector and a first unlocked position to release the mating electrical connector. The second locking feature may have a second locked position to lock the mating electrical connector and a second unlocked position to release the mating electrical connector. The first locking feature and the second locking feature may be configured for locking different sides of the mating electrical connector, respectively.

Optionally, the CPA device may further include a first operating member and a third locking feature. The first operating member may be operable along a predetermined direction. The first locking feature may be movable from the first locked position to the first unlocked position based on the operation of the first operating member. The third locking feature may have a third locking position and a third unlocked position. The third locking feature may be configured to lock the first operating member when in the third locked position such that the first locking feature is retained in the first locked position; and the third locking feature may be further configured to release the first operating member when in the third unlocked position such that the first operating member is operable.

Some embodiments relate to a connector position assurance (CPA) device. The CPA device may comprise a first operating member, a first locking feature and a third locking feature. The first operating member may be operable along a predetermined direction. The first locking feature may have a first locked position to lock a mating electrical connector and a first unlocked position to release the mating electrical connector. The first locking feature may be movable from the first locked position to the first unlocked position based on the operation of the first operating member. The third locking feature may have a third locking position and a third unlocked position. The third locking feature may be configured to lock the first operating member when in the third locked position such that the first locking feature is retained in the first locked position; and the third locking feature may be further configured to release the first operating member when in the third unlocked position such that the first operating member is operable.

Optionally, the CPA device may further include a second locking feature, having a second locked position to lock the mating electrical connector and a second unlocked position to release the mating electrical connector. The first locking feature and the second locking feature may be configured for locking different sides of the mating electrical connector, respectively.

Optionally, the first locking feature may include a first locking head for locking with the mating electrical connector, a first tail for coupling to the first operating member, and an intermediate portion joining the first locking head and the first tail. The intermediate portion may be pivotably connected to the housing assembly about a first predetermined axis such that the first locking feature is pivotable between the first locked position and the first unlocked position.

Optionally, the first locking feature may include a bent resilient beam configured to bias the first locking feature toward the first locked position.

Optionally, the first operating member may be configured to be returnable to an initial position for locking with the third locking feature under the bias of the resilient beam.

Optionally, the first tail may have a V-shaped slot. The first operating member may be slidable along a sidewall of the V-shaped slot such that the first locking feature is pivotable between the first locked position and the first unlocked position.

Some embodiments relate to an electrical connector. The electrical connector may comprise a main housing, a plurality of conductive terminals, a cage, and an outer housing. The main housing may include a second mating portion for mating with a mating electrical connector and a second mounting portion. The plurality of conductive terminals may be held by the main housing and extend from the second mating portion to the second mounting portion. The cage may surround outside the main housing, and have a front portion extending beyond the second mating portion. The outer housing may be attached to the front portion of the cage and include a complementary locking feature configured to engage with a locking feature of the mating electrical connector.

Optionally, the cage may be formed by bending a metal sheet. Edges of the metal sheet opposite each other may be formed with a mortise and tenon structure such that the edges of the metal sheet are interconnected with each other.

Optionally, the cage may include a barb protruding outwardly, and the outer housing may be provided with an opening for engaging with the barb.

Optionally, the cage may include a board lock located outside of the outer housing.

Optionally, an inner surface of the cage and an outer surface of the second mating portion may be spaced apart to form a gap for receiving a first mating portion of the mating electrical connector.

Optionally, the outer housing may be sleeved over the front portion of the cage, and the outer housing may include a locking portion extending beyond the front end and have the complementary locking feature disposed thereon.

Optionally, the second mating portion and the second mounting portion may be perpendicular to each other.

Optionally, the outer housing may have a first dimension along a first lateral direction and a second dimension along a second lateral direction. The first dimension may be greater than the second dimension. The first lateral direction and the second lateral direction may be perpendicular to each other and perpendicular to a mating direction of the electrical connector to the mating electrical connector. The outer housing may have first walls opposite each other along the first lateral direction and second walls opposite each other along the second lateral direction. The second walls may have a bulge outwardly protruding. The complementary locking feature may include first openings in the first walls and a second opening in the bulge.

The techniques described herein may be used alone or in any suitable combination. The foregoing summary is provided by way of illustration and is not intended to be limiting.

### BRIEF DESCRIPTION OF THE DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is a perspective view of an electronic system comprising a first electrical connector and a mating second electrical connector connected fully mated with each other, according to some embodiments.

FIG. 1B is a perspective view of the electronic system of FIG. 1A, illustrating the first electrical connector and the mating second electrical connector partially mated/unmated with each other.

FIG. 1C is a side view of the electronic system of FIG. 1B.

FIG. 1D is a top view of the electronic system of FIG. 1B.

FIG. 1E is a perspective view of the electronic system of FIG. 1A, illustrating the first electrical connector and the mating second electrical connector separated from each other.

FIG. 1F is a partially enlarged cross-sectional view of the electronic system of FIG. 1A.

FIG. 1G is a partially enlarged cross-sectional view of the electronic system of FIG. 1B.

FIG. 1H is a partially enlarged cross-sectional view of the electronic system of FIG. 1E.

FIG. 2A is a top, front perspective view of the first electrical connector of the electronic system of FIG. 1A.

FIG. 2B is a partially enlarged view of the first electrical connector of FIG. 2A, illustrating a second operating member without a pressing force applied thereon.

FIG. 2C is a partially enlarged view of the first electrical connector of FIG. 2B, illustrating the second operating member with a pressing force applied thereon.

FIG. 2D is a top view of the first electrical connector of FIG. 2A.

FIG. 2E is a partially enlarged cross-sectional view of the electrical connector of FIG. 2B.

FIG. 2F is a partially enlarged cross-sectional view of the first electrical connector of FIG. 2C.

FIG. 2G is a partially exploded view of the first electrical connector of FIG. 2A.

FIG. 2H is a top, rear perspective view of the first electrical connector of FIG. 2A, with a portion thereof exploded.

FIG. 2I is a bottom, rear perspective view of the first electrical connector of FIG. 2A, with another portion thereof exploded.

FIG. 3 is a perspective view of the first electrical connector of FIG. 2A, illustrating a third housing and the second operating member hidden.

FIG. 4A is a perspective view of a module of the first electrical connector of FIG. 2A.

FIG. 4B is a perspective view of the module of FIG. 4A, with a module housing hidden.

FIGS. 5A-5C are perspective, side and top views of a first locking feature of the first electrical connector of FIG. 2A, respectively.

FIGS. 6A-6C are perspective, side and top views of a second operating member of the first electrical connector of FIG. 2A, respectively.

FIG. 7 is a perspective view of a first housing of the first electrical connector of FIG. 2A.

FIG. 8 is a perspective view of the first electrical connector of FIG. 2A, with a first operating member exploded.

FIG. 9 is a perspective view of the first electrical connector of FIG. 2A, with the first operating member assembled.

FIGS. 10A-10B are simplified views of the first housing of FIG. 7 with respective to the first operating member.

FIG. 11A is a top, rear perspective view of a second electrical connector of the electronic system of FIG. 1A.

FIG. 11B shows a cross-sectional perspective view of the second electrical connector of FIG. 11A.

FIG. 12A is a perspective view of a cage of the second electrical connector of FIG. 11A.

FIG. 12B is a bottom, rear perspective view of the cage of FIG. 12A.

FIG. 13A is an exploded perspective view of the second electrical connector of FIG. 11A, with portions hidden, showing a main housing and conductive terminals.

FIG. 13B is a perspective view of the second electrical connector of FIG. 13A.

FIG. 14 is a perspective view of an outer housing of the second electrical connector of FIG. 11A.

The above accompanying drawings include the following reference signs:

100, first electrical connector; 110, housing assembly; 111, first housing; 110A, first mating portion; 110B, first body; 1111, first mounting channel; 1112, first cable connection portion; 1113, first slot; 1114, second slot; 112, second housing; 1121, opening; 1122, mounting opening; 1123, aperture; 1124, snap slot; 1125, first cut; 113, third housing; 1131, snap; 1131A, flat surface; 1131B, guide bevel; 1132, second cut; 114, strain relief member; 1141, cross member; 1142, break; 115, second positioning post; 120, circuit board; 121A, first end; 121B, second end; 122, conductive pad; 122A, first conductive pad; 122B, second conductive pad; 123, inclined surface; 124, slot; 131, high-speed data cable; 131A, end of high-speed data cable; 132, power cable; 141, first locking feature; 1411, first locking head; 1411A, hook; 1411B, guide; 1411C, outer surface; 1411E, opening; 1412, first tail; 1412A, first sidewall; 1412B, second sidewall; 1413, first intermediate portion; 1413A, hole; 1414, resilient beam; 142, second locking feature; 143, third locking feature; 144, first operating member; 1441, first operating portion; 1442, opening; 1443, pillar; 1444, crossbeam; 1445, first arm; 1446, second arm; 145, second operating member; 1451, pressing portion; 1452, second shaft; 1454, first positioning post; 150, first shaft; 160, resilient member; 170, module housing; 200, second electrical connector; 210, main housing; 211, second mating portion; 211A, groove; 211B, second mating end; 211C, second mounting end; 212, second mounting portion; 2121, protrusion; 2122, latch; 220, conductive terminal; 221, mating end; 222, mounting end; 223, intermediate portion; 223A, curved portion; 230, cage; 231, mortise and tenon; 232, barb; 233, board lock; 233A, first protrusion; 233B, second protrusion; 234, front portion; 235, resilient sheet; 240, outer housing; 2401, first wall; 2402, second wall; 2402A, bulge; 241, locking portion; 242, opening; 251, first complementary locking feature; 252, second complementary locking feature; 260, gap.

### DETAILED DESCRIPTION

The Inventors have recognized and appreciated connector design techniques that enable high-speed, high-density connectors and interconnection systems thereof that may operate reliably in the harsh environment presented by an automobile. Techniques described herein may provide hybrid electrical connectors that can be used to maintain signal integrity for high-speed signal transmission in harsh environments, such as those encountered in vehicles, while providing reliable power supply. Techniques described herein may enable economically assembling such hybrid electrical connectors.

According to aspects of the present disclosure, an interconnection system may include an electrical connector and a mating electrical connector. The electrical connector may include a housing assembly, a module, and a connector position assurance (CPA) device. The module may include densely disposed conductive pads. The module may include a circuit board with the conductive pads and high-speed data cables having ends mounted onto the conductive pads. The CPA device may be disposed on the housing assembly, and configured for securing the electrical connector to the mating connector. The CPA device may include locking features disposed on different sides of the housing assembly, which can improve reliability. The mating electrical connector may include an outer housing having complementary locking features. The connectors can be electrically connected as long as a first locking feature in its locked position. Such techniques can enable interconnection systems for harsh environments such as one presented by an automobile.

In some embodiments, an electrical connector may comprise a first locking feature and a second locking feature, which may be used to position the electrical connector to a mating electrical connector on different sides when the two are mated with each other. The first locking feature and the second locking feature may provide position assurance along different directions, so that a reliable connection can be provided with respect to vibrations in various directions.

In some embodiments, the first locking feature and the second locking feature may be provided with a first operating member and a second operating member, respectively, for unlocking. The first operating member and the second operating member may have different operation manners and/or different operation directions. The locking features may be unlocked by different manners, so that the probability that the electrical connectors are disconnected due to accidental external factors can be reduced. Exemplary manners include pushing in, pressing, pulling, rotating, etc. Optionally, the first operating member and the second operating member may be operated in different manners. Optionally, the first operating member and the second operating member may be operated in different directions. In some embodiments, a combination of operation manners may make the electrical connectors compact in structure and achieve economical assembly of the electrical connectors, e.g., a combination of pressing and an outward pulling.

In some embodiments, a third locking feature may be provided for one or more of the operating members. The third locking feature may be configured to avoid mis-operation, which may lead to accidental unlocking of the corresponding locking feature. In some embodiments, the third locking feature may be provided for the pulling-type first operating member. It may be troublesome for a user to operate simultaneously two or more members, and particularly in a narrow or cable-intensive space. In some embodiments, the second locking feature and the third locking feature may be designed to linked, such that when the second operating member is operated to unlock the second locking feature, the third locking feature can also be unlocked, and thus the first operating member can be released so as to be in an operable state. Optionally, the electrical connector may be configured such that when the second locking feature is unlocked, the electrical connector can move to a partially mated/unmated position with respect to the mating electrical connector. The third locking feature may also be maintained in its unlocked position, and the user may freely operate the first operating member to unlock the first locking feature, realizing one-handed unlocking operation.

In some embodiments, a mating electrical connector may include locking features that are complementary to the aforementioned first locking feature and the second locking feature. The mating electrical connector may include a main housing that holds a plurality of conductive terminals, an outer housing, and a cage connecting the main housing and the outer housing. In some embodiments, a front portion of the cage may extend beyond the main housing. The outer housing may be connected to the front portion of the cage and include a locking portion extending beyond the front portion of the cage. The locking portion of the outer housing may include the locking features. In some embodiments, the locking portion of the outer housing may include first walls opposite each other and a second wall joining the first walls. The second wall may include a bulge protruding outwardly. The first walls may include first openings extending therethrough as locking features. The bulge of the second wall may include a second opening extending therethrough as a locking feature.

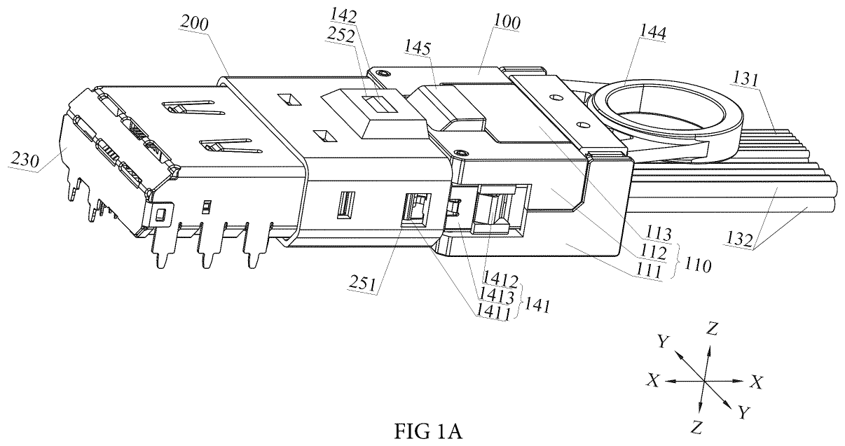

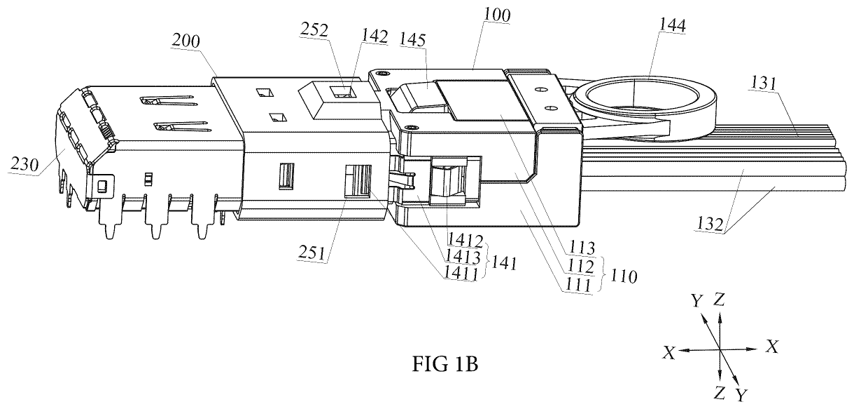

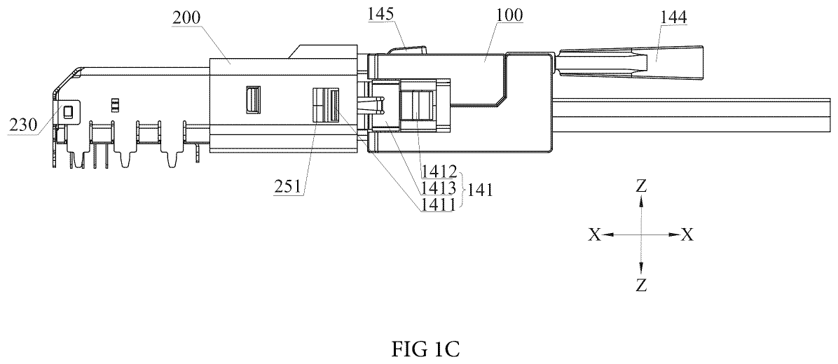

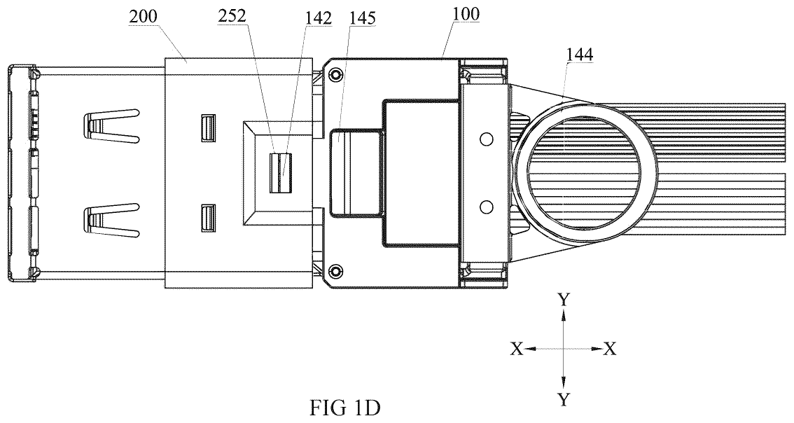

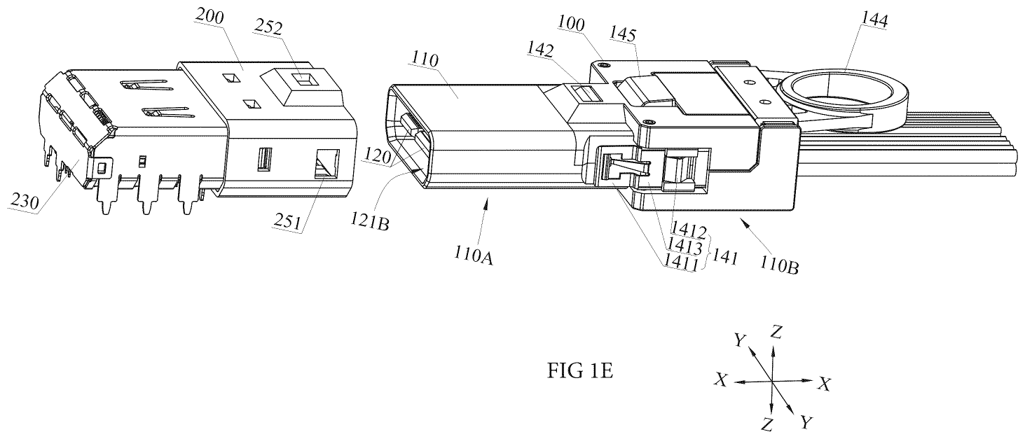

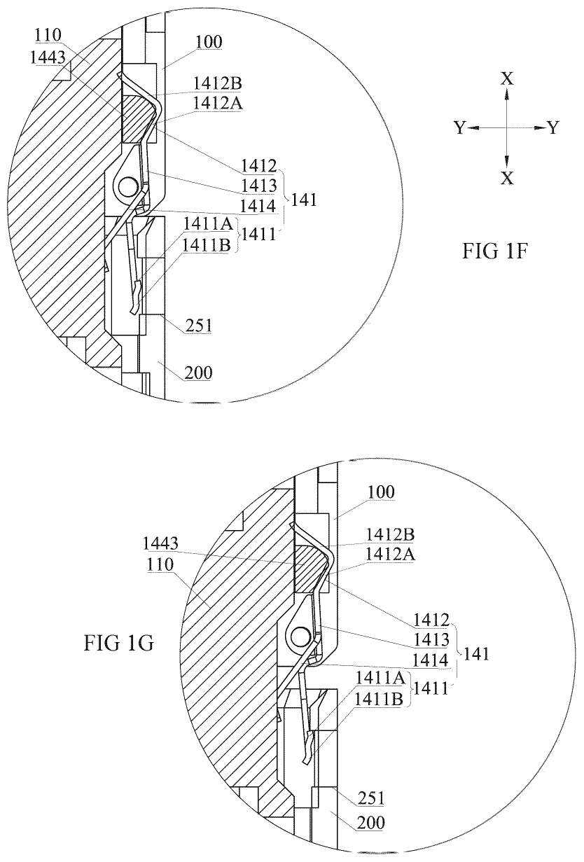

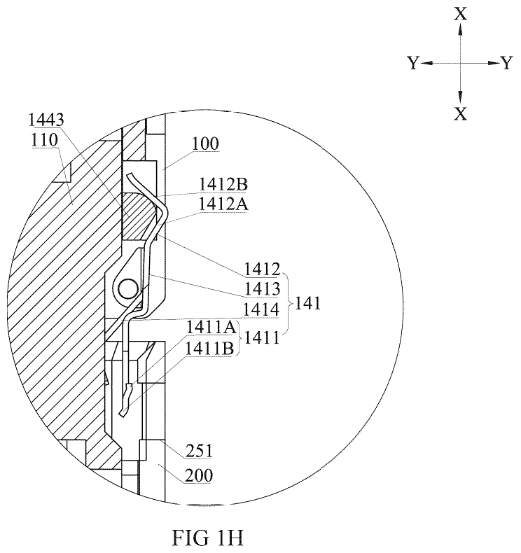

FIGS. 1A to 1E illustrate a portion of an electronic system, for example, used in a vehicle, for interconnecting a plurality of electronic devices in the electronic system. As shown, the electronic system may comprise a first electrical connector 100 and a second electrical connector 200 that are detachably mated to each other. The second electrical connector 200 may be mounted onto a first circuit board (not shown). The first electrical connector 100 may be a cable connector. The first electrical connector 100 may be electrically connected via cables to an electronic device (not shown), such as a second circuit board. The first electrical connector 100 and the second electrical connector 200 may provide an interconnection between the electronic device and the first circuit board. The electronic device may be spaced apart from the first circuit board by a distance. For example, the second electrical connector 200 is a socket electrical connector mounted onto the first circuit board. The first electrical connector 100, as a plug electrical connector, may be mated with the socket electrical connector. In some embodiments, the first electrical connector may be mounted directly onto a circuit board, and the second electrical connector is configured as a cable connector, so as to interconnect a further electronic device with the circuit board. Optionally, both the first electrical connector and the second electrical connector are connected to respective electronic devices, such as circuit boards, via cables. One of the first electrical connector and the second electrical connector may be fixed to a target electronic device. In harsh environments such as those presented by an automobile, the electronic system may provide high-speed data transmission while withstanding vibrations.

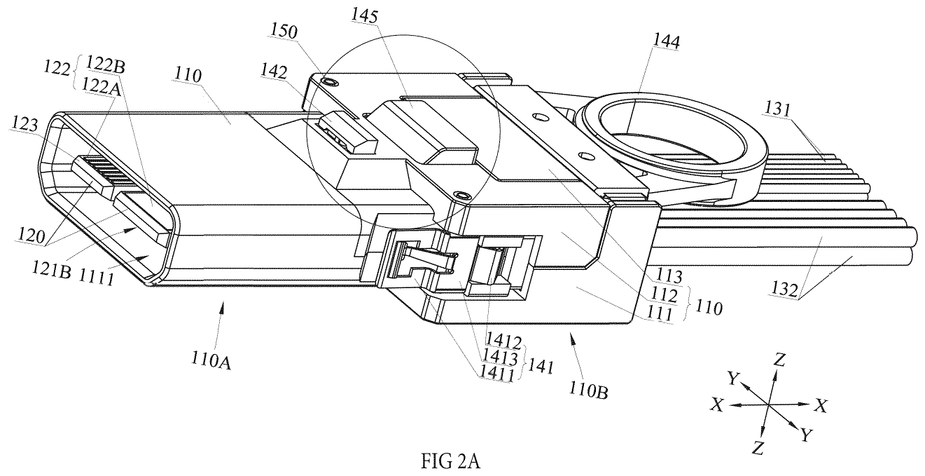

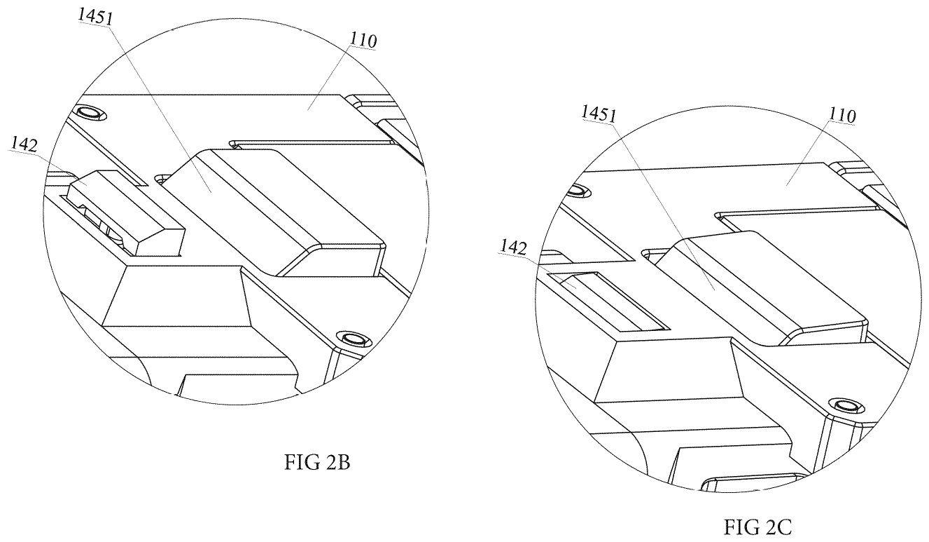

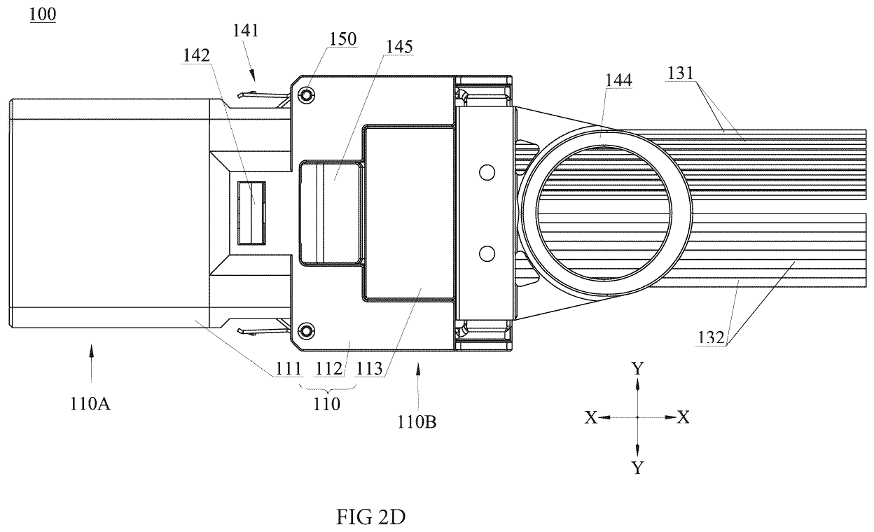

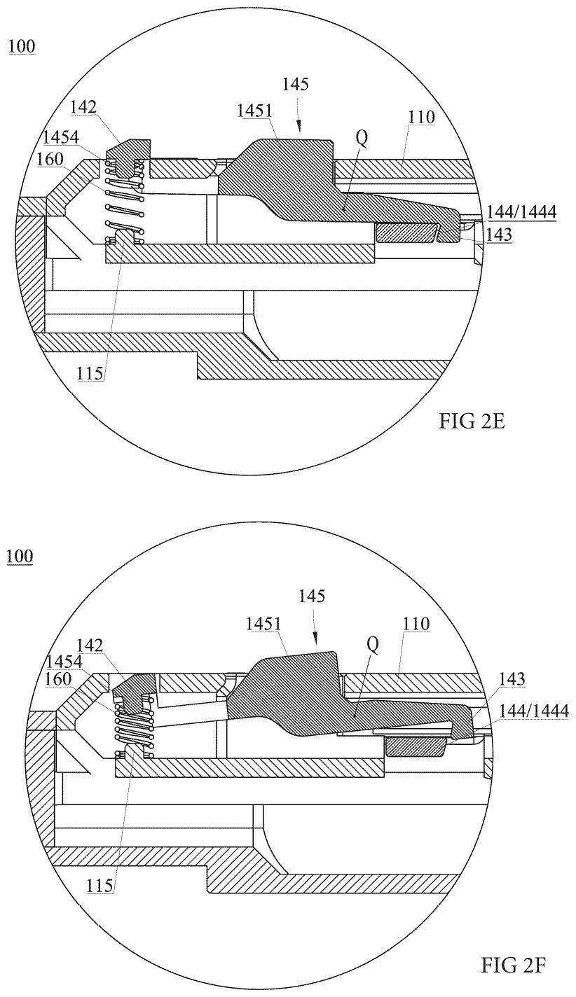

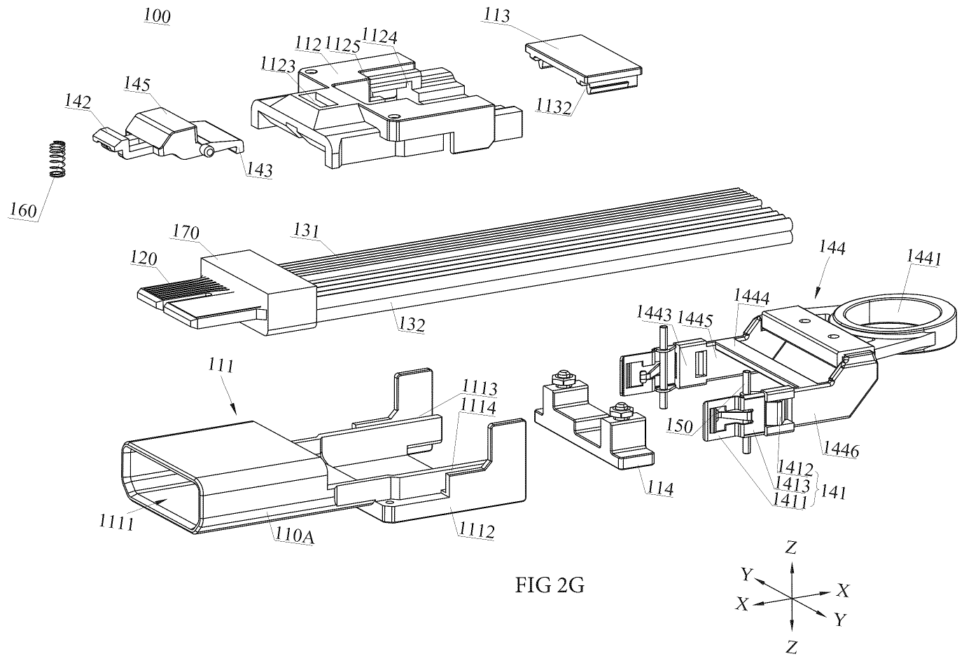

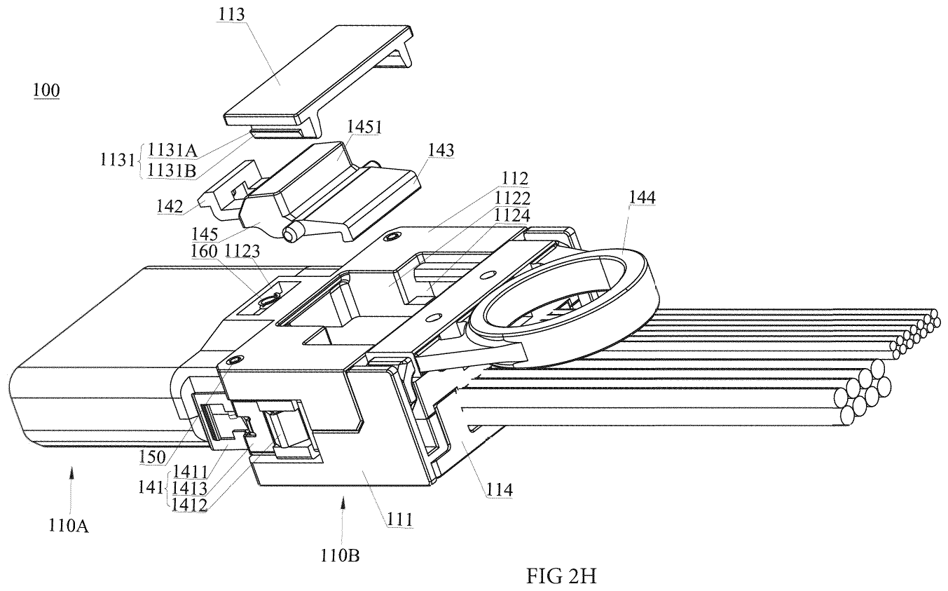

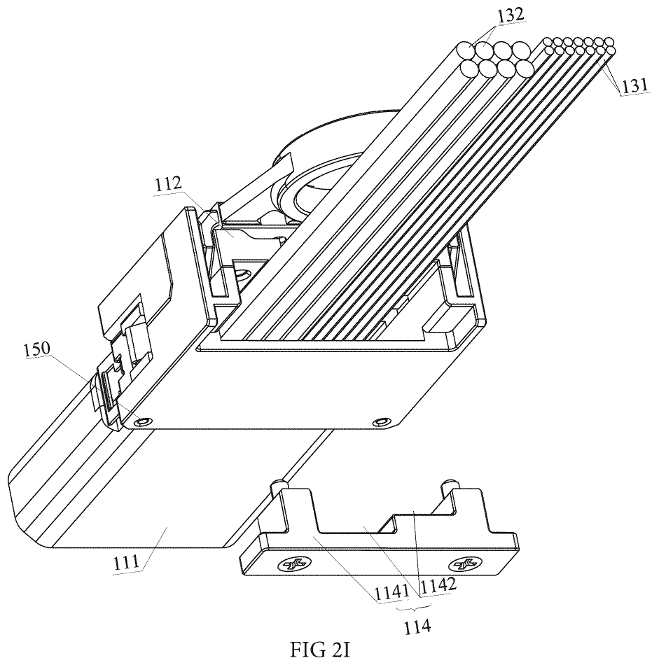

FIGS. 2A-2I illustrate the first electrical connector 100 according to some embodiments of the present disclosure. For clear and concise description, a mating direction X-X, a first lateral direction Y-Y and a second lateral direction Z-Z are shown in the drawings. The mating direction X-X may be the direction in which the first electrical connector 100 is mated to the second electrical connector 200. The first lateral direction Y-Y and the second lateral direction Z-Z may be both perpendicular to the mating direction X-X, and the first lateral direction Y-Y and the second lateral direction Z-Z may be perpendicular to each other.

In the illustrated example, the first electrical connector 100 may include a housing assembly 110. The housing assembly 110 may include a first mating portion 110A. The first mating portion 110A is configured to match the second electrical connector 200 in shape, such that the first electrical connector 100 can be precisely positioned onto the second electrical connector 200 once they are mated together. The conductors in the first electrical connector 100 and the second electrical connector 200 can be reliably and correspondingly electrically connected. In addition, the housing assembly 110 may further comprise a first body 110B. The housing assembly 110 may be molded with an insulating material, such as plastic. Plastic may include but not limited to liquid crystal polymer (LCP), polyphenylene sulfite (PPS), high-temperature nylon or poly-p-phenylene oxide (PPO), or polypropylene (PP), or other materials may be used. In some cases, plastic may be thermosetting plastic. In some cases, insulating plastic may include such as fiberglass-reinforced insulating material.

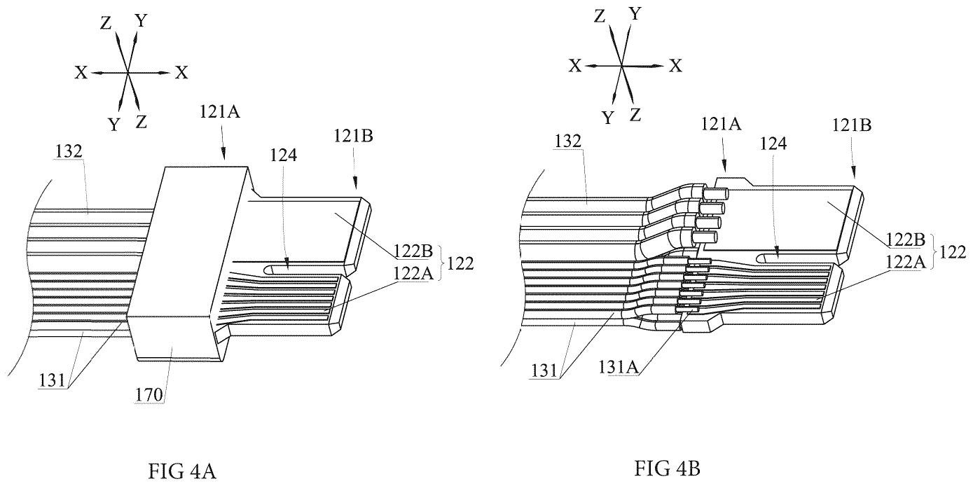

The first electrical connector 100 may include a circuit board 120, as shown in FIGS. 4A and 4B. The circuit board 120 may be disposed inside the housing assembly 110, and the circuit board 120 includes a plurality of conductive pads 122 for electrical contact with a mating electrical connector. A substrate of the circuit board 120 may be made of a fiberglass-reinforced material. Optionally, the substrate may be made of Teflon, in the case that the circuit board 120 is used for transmitting high-speed data signals. The conductive pads 122 may be formed on the circuit board 120 by printing or machining. Adjacent conductive pads 122 are spaced suitably to reduce the risk of short circuit and crosstalk. Optionally, metal layers may be formed on the surfaces of the conductive pads 122 to avoid poor contact due to oxidation. In some embodiments, the conductive pads 122 may be gold fingers arranged densely. Optionally, the circuit board 120 may be substantially accommodated inside the first mating portion 110A of the housing assembly 110. When the first electrical connector 100 are mated to the second electrical connector 200, the circuit board 120 may be inserted into the second electrical connector 200 such that the conductive pads 122 on the circuit board 120 are in electrical contact with corresponding conductive elements of the second electrical connector 200. The density of conductive pads 122 on the circuit board 120 can be increased as needed, so as to satisfying the need for high-density signal transmission. The circuit board 120 may include a first end 121A in the interior of the housing assembly 110 and a second end 121B facing the second electrical connector 200 along the mating direction X-X. The second end 121B may be chamfered so as to form an inclined surface 123 that serves as a guide during insertion into the mating electrical connector.

The plurality of conductive pads 122 in the first electrical connector 100 may be used to transmit high-speed data signals and/or power signals. Optionally, the conductive pads 122 may be used entirely for transmitting high-speed data signals or entirely for transmitting power signals. Optionally, a portion of the conductive pads 122 may be used for transmitting high-speed data signals and the others for transmitting power signals. Conductive pads 122 may transmit electrical power when transmitting power signals.

The first electrical connector 100 may further include a plurality of high-speed data cables 131. Ends 131A of the plurality of high-speed data cables 131 may be attached to the circuit board 120 and in electrical contact with the plurality of conductive pads 122. In the illustrated example, at least a portion of the conductive pads 122 are used to transmit high-speed data signals. The ends 131A of the high-speed data cables 131 may be connected to pads on the first end 121A of the circuit board 120 by, for example, brazing, spot welding or ultrasonic welding, such that the ends 131A are reliably fixed and electrically connected to the pads. The pads are connected with respective conductive pads 122 via conductive traces in the circuit board 120 such that the plurality of high-speed data cables 131 are electrically connected to the plurality of conductive pads 122. The plurality of high-speed data cables 131 may extend through the first body 110B of the housing assembly 110 to the first mating portion 110A. In the illustrated example, the high-speed data cables 131 extend substantially along the mating direction X-X. Optionally, the high-speed data cables may be bent, for example, to 90 degrees or any other suitable angle. In this case, the first body 110B may have a curved portion to be adapted to bends of the high-speed data cables. The ends 131A of the high-speed data cables 131 together with the first end 121A of the circuit board 120 may be cladded in the housing assembly 110, so as to avoid short circuit caused by moisture, oxidization or foreign matters, and to avoid the high-speed data cables 131 from separation from the circuit board 120 by external forces.

The high-speed data cables 131 may generally have electrical properties superior to low-speed data cables for transmitting low-speed data signals. Accordingly, the first electrical connector 100 may be backwardly compatible for transmitting low-speed data signals, such as low frequency signals (e.g., with a frequency of less than 66 MHZ), signals with lower data rates (e.g., less than 100 Mb/s). The low-speed data signals may typically include auxiliary information and/or control signals responsible for supporting and managing data transmission, rather than primary data. The control signals may include one or more of control commands, status information, error detection and correction, and the like. The auxiliary information may include one or more of checksums, flow control, clock synchronization, and the like. The auxiliary information may improve data integrity, reliability and synchronization. Optionally, the first electrical connector 100 may be used to transmit high-speed data signals or low-speed data signals. Optionally, the first electrical connector 100 may be used to transmit both high-speed data signals and low-speed data signals.

The first electrical connector 100 may include a power cable 132. As shown in FIGS. 4A and 4B, the conductive pads 122 on the circuit board 120 may include a plurality of first conductive pads 122A spaced apart mutually and electrically connected to the high-speed data cables 131, so as to cooperate with the mating electrical connector to provide transmission of high-speed data. The conductive pads 122 may include a wide second conductive pad 122B that may be electrically connected to the power cable 132 and cooperate with the mating electrical connector to transmit electrical power. In some embodiments, the power cable 132 may include a plurality of thin cables in parallel rather than a single thick cable, such that the difficulties of assembling and soldering can be reduced. For example, each cable has a conductive portion with a circular cross-section, and narrower than a portion of the second conductive pad 122B connected to the power cable 132. A thick cable may need to be flattened before connected to the second conductive pad 122B to enlarge contact area and lower contact resistances. This results in a more complex process and difficulty in ensuring quality. The thick cable also causes an increased dimension of the first electrical connector 100 in the second lateral direction Z-Z. In comparison, where the power cable 132 includes a plurality of thin cables connected to the second conductive pad 122B in parallel, the dimension may be increased in the first lateral direction Y-Y only. Since the first electrical connector 100 may have space to accommodate the power cable 132 in the first lateral direction Y-Y, the outline dimensions of the first electrical connector 100 may be unchanged. The plurality of thin cables may also ensure the reliability of the power supply. Even if one or more of the cables are disabled, the power supply may not be interrupted completely. Optionally, there may be a plurality of second conductive pads spaced apart from one another. In some embodiments, the circuit board 120 may include a slot 124, which divides the circuit board 120 into a power portion and a high-speed data portion. The second conductive pad 122B may be disposed on a front side and/or a reverse side of the power portion and the first conductive pads 122A may be disposed on a front side and/or a reverse side of the high-speed data portion. As the first electrical connector 100 is mated with the second electrical connector 200, the slot 124 may fit to a projection of the mating electrical connector so as to be dummy-proof. The slot 124 may also separate the second conductive pad 122B for transmitting electrical power, from the first conductive pads 122A for transmitting high-speed data to some extent, thereby minimizing interference. In some embodiments, the slot 124 may be formed by two spaced apart circuit boards.

The first electrical connector 100 may include a connector position assurance (CPA) device, which is disposed on the housing assembly 110. In some embodiments, the CPA device may adopt one of latch, threaded connection and snap, or any combination of the above, provided that the first electrical connector 100 can be locked to the second electrical connector 200 when they are mated. The first electrical connector 100 can be protected from potential accidentally detaching from the mating electrical connector due to vibrations or external forces.

The first electrical connector 100 may include the circuit board 120. The circuit board 120 may include the conductive pads 122 for electrical contact with the mating second electrical connector. In contrast to each contact being fabricated as a separate conductor mounted into the housing assembly 110, the density of conductive pads 122 can be increased by fabricating the conductive pads 122 on the circuit board 120, but the dimensions of the first electrical connector 100 and the mating second electrical connector 200 are not significantly altered. Moreover, the conductive pads 122 can be precisely positioned on the circuit board 120 and different batches of the products can have higher consistency. Signal integrity is improved even when high-speed data signals are transmitted. Signal transmission may not be affected even in a harsh environment (e.g., such as one presented by an automobile), since the first electrical connector 100 is in reliable electrical connection to the mating second electrical connector 200 by the CPA device.

In some embodiments, the plurality of high-speed data cables 131 may conform to Peripheral Component Interconnect Express Generation 5 (PCIE Gen 5) and/or Generation 6 (PCIE Gen 6) for transmission rates. High-speed data transmission usually requires high frequency signals as carrier waves to ensure sufficient bandwidth. High frequency signals may be significantly affected by many factors, such as conductor impedance, skin effect. Moreover, external interference may also seriously affect the high-speed data transmission, resulting in data loss. In this regard, the high-speed data cables 131 can adopt cables with shield layers connected to the signal grounds and are in pairs for transmitting differential signals, to eliminate signal interference from external electric and magnetic fields to a certain extent. Meanwhile, the electric and magnetic fields of the cables in each pair may mutually offset, and reduced electromagnetic radiation is less likely to interfere with other devices. The high-speed data cables 131 may be simplified in the drawings, without showing the structural details, such as shield layers.

In some embodiments, a pitch between adjacent high-speed data cables 131 is less than or equal to 1 mm to meet the requirements of high-density cables, which provide a prerequisite for high-density signal transmission. The first electrical connector 100 may support high bandwidth data transmission and be backwardly compatible for low bandwidth data transmission. For example, for devices that communicate at high bandwidths, all high-speed data cables 131 may be used. For devices that communicate at low bandwidths, a portion of the high-speed data cables 131 may be used, with the rest being idle. In some applications, in some embodiments, a portion of the high-speed data cables 131 in a device A may be used to receive data from a device B and another portion of the high-speed data cables 131 may be used to transmit data to the device B, thereby receiving and transmitting data simultaneously, and realizing full-duplex communication.

Referring back to FIG. 1A, in some embodiments, the CPA device may include a first locking feature 141. The first locking feature 141 has a first locked position for locking the second electrical connector 200 and a first unlocked position for releasing the second electrical connector 200. In some embodiments, the CPA device may also include a second locking feature 142. The second locking feature 142 has a second locked position for locking the second electrical connector 200 and a second unlocked position for releasing the second electrical connector 200. The first locking feature 141 and the second locking feature 142 may be applied on different sides of the second electrical connector 200, respectively. High stresses may be generated between the locking features of the first electrical connector 100 and complementary locking features of the mating electrical connector when subjected to external forces. If the locking features are disposed on the same side of the first electrical connector 100, the deterioration of the CPA device and the complementary locking features on the mating electrical connector may be accelerated in a harsh environment, such as one presented by an automobile, resulting in the failure of the CPA device. The vibrations may be unidirectional and regular in such a harsh environment. Thus, once the vibration direction substantially coincides with the locking direction of the locking features, the locking features may be failed collectively. In addition, in a trend of miniaturization, the first electrical connector 100 is not adequate for accommodating both the first locking feature 141 and the second locking feature 142 on the same side, and the same is true for the second electrical connector 200. The mechanical strength of the first electrical connector 100 and the second electrical connector 200 can be less impacted by disposing the first locking feature 141 and the second locking feature 142 on different sides of the first electrical connector 100. As shown in FIGS. 2A and 2B, the first electrical connector 100 may have a larger dimension in the first lateral direction Y-Y than that in the second lateral direction Z-Z. The first locking feature 141 may be disposed on sides of the first electrical connector 100 opposite in the first lateral direction Y-Y. Correspondingly, the second locking feature 142 may be disposed on one or two of sides of the first electrical connector 100 opposite in the second lateral direction Z-Z. As a result, three-point locking is possible. In this case, the second locking feature 142 may be dimensionally larger than the first locking feature 141. When the second locking feature 142 is disposed on one side of the first electrical connector 100, the second locking feature 142 may include a larger locking projection that can withstand a pulling force which is at least greater than that a single first locking feature 141 can withstand. The larger second locking feature 142 can withstand a larger pulling force and evenly spread that pulling force to avoid stress concentration that may lead to deformation and fracture. Optionally, the second locking feature 142 may be disposed on both sides of the first electrical connector 100 opposite in the second lateral direction Z-Z. The first electrical connector 100 may become relatively complex in structure, and the dimension may become greater in the second lateral direction Z-Z. These locking features may be redesigned in number and arrangement by those skilled in the art, as appropriate.

In some embodiments, the first locking feature 141 and the second locking feature 142 may be movable between their respective locked positions and unlocked positions. In order to differentiate, the locked positions of the first locking feature 141 and the second locking feature 142 may be referred to as a first locked position and a second locked position, respectively, and their unlocked positions may be referred to as a first unlocked position and a second unlocked position, respectively. When the first electrical connector 100 is connected in place with the second electrical connector 200 as shown in FIG. 1A, the first locking feature 141 and the second locking feature 142 may be coupled to the first complementary locking feature 251 and the second complementary locking feature 252 on the second electrical connector 200, respectively. In some embodiments, the first complementary locking feature 251 and the second complementary locking feature 252 may be configured as openings, grooves, and/or stop projections, provided that they are capable of coupling to the first locking feature 141 and the second locking feature 142, respectively. When the first electrical connector 100 vibrates in an operating environment, the CPA device of the first electrical connector 100 may substantially withstand component forces of the external forces in the mating direction X-X, and component forces in directions perpendicular to the mating direction X-X may be borne substantially by the second electrical connector 200 and the first mating portion 110A of the housing assembly 110 inserted into the second electrical connector 200. In some embodiments, the first locking feature 141 and the second locking feature 142 may withstand the component forces in the mating direction X-X in different periods. For example, when one of the first locking feature 141 and the second locking feature 142 fails, the other can still work. There may be one or more first locking features 141 and second locking features 142. Optionally, when the first electrical connector 100 is subjected to a pulling force, the second locking feature 142 is first subjected to the component forces in the mating direction X-X. When the second locking feature 142 is in the second locked position, the second locking feature 142 may be engaged with the second complementary locking feature 252, such as notch or opening, to reduce the risk of relative displacement of the first electrical connector 100 to the second electrical connector 200. When the second locking feature 142 is in the second unlocked position, the second locking feature 142 is disengaged from the second complementary locking feature 252 on the second electrical connector 200. In this case, the first electrical connector 100 may be movable relative to the second electrical connector 200 in the mating direction X-X within a certain range, and the first locking feature 141 may still couple to the corresponding first complementary locking feature 251 on the second electrical connector 200. When the first electrical connector 100 is moved to a boundary of the above range, the first electrical connector 100 is in a partially mated/unmated position, as shown in FIGS. 1B to 1D. At this point, although the second locking feature 142 is disengaged from the second complementary locking feature 252, the first locking feature 141 is engaged with the first complementary locking feature 251, such that the first electrical connector 100 is still connected with the second electrical connector 200. In some embodiments, the first electrical connector 100 and the second electrical connector 200 may remain in electrical contact when the first electrical connector 100 is moved within the range along the mating direction X-X. If the first locking feature 141 is in the first unlocked position and the external forces are continuously applied on the first electrical connector 100 in the mating direction X-X, the first electrical connector 100 may be completely detached from the second electrical connector 200. FIG. 1E illustrates the first electrical connector 100 in a complete detachment state.

FIGS. 1F to 1H show partial enlarged views of the first electrical connector 100 in mated position, partially mated/unmated position, and complete detachment position, respectively, with respect to the second electrical connector 200. In some embodiments, the first locking feature 141 may include a hook 1411A protruding along the first lateral direction Y-Y beyond the housing assembly 110. When the first locking feature 141 is in the first locked position and the second locking feature 142 is in the second locked position, as shown in FIG. 1F, the hook 1411A may extend into the first complementary locking feature 251, such as opening. When the second locking feature 142 is in the second unlocked position, the first locking feature 141 may be limited by the first complementary locking feature 251 such that the first electrical connector 100 is movable between the mated position with the second electrical connector 200, as shown in FIG. 1F, and the partially mated/unmated position, as shown in FIG. 1G. Referring to FIG. 1G, in the partially mated/unmated position, the hook 1411A is hooked at the edge of the first complementary locking feature 251, so that even if the second locking feature 142 fails during the operation, the first electrical connector 100 and the second electrical connector 200 can still be kept in a connected state by the first locking feature 141. When the first electrical connector 100 need to be completely detached from the second electrical connector 200, the first locking feature 141 can be placed in the first unlocked position, as shown in FIG. 1H, such that the hook 1411A can be disengaged from the first complementary locking feature 251 of the second electrical connector 200. Thereupon, the first electrical connector 100 can be completely detached from the second electrical connector 200, as shown in FIG. 1E. In some embodiments, the first locking feature 141 may be unlocked based on the operation of the first operating member as described below.

In some embodiments, the CPA device may include a first operating member 144 operable along a predetermined direction. The first locking feature 141 may be moved from the first locked position to the first unlocked position by operating the first operating member 144. The first operating member 144 may have any other suitable structure, such as button, disposed on the housing assembly 110. In the illustrated example, the first operating member 144 may include a pull tab. As shown in FIG. 1E, the first operating member 144 may be mounted onto the first body 110B of the housing assembly 110. The pull tab may be disposed on a side of the first body 110B opposite the first mating portion 110A. In some embodiments, the predetermined direction may be the mating direction X-X of the first electrical connector 100 with the mating second electrical connector 200. In this case, the first locking feature 141 may be unlocked by pulling the first operating member 144 outwardly along the mating direction X-X, such that the first electrical connector 100 can be detached from the second electrical connector 200 whereby. This is more in line with operating habits of a user. Optionally, the first operating member may also be operated by rotating, pressing, etc., in which case the predetermined direction may be at an angle to the mating direction X-X of the first electrical connector 100, or even opposite the pull-out direction of the first electrical connector 100. In some embodiments, the first operating member 144 may be coupled to the first locking feature 141. As the user operates the first operating member 144, the first locking feature 141 may be moved from the first locked position to the first unlocked position by a mechanical structure, such as bulge, oblique surface, and gear. In a natural state, the first locking feature 141 may be retained in the first locked position, which can reduce the risk of the first locking feature 141 failing in the partially mated/unmated state and cause the first electrical connector 100 to completely detach from the second electrical connector 200 accidentally. The number of parts can be reduced and the structure can be simplified by this mechanical linkage design, thereby to reduce dimensions and ensure reliable operation.

FIGS. 2A to 2I illustrate a first electrical connector 100 according to an exemplary embodiment of the present disclosure. Optionally, a second locking feature 142 of the first electrical connector 100 may be a snap. Referring to FIG. 1B and FIG. 2C in conjunction, the second locking feature 142 is moved toward the inside of the first electrical connector 100 under resilience, as the first electrical connector 100 is inserted into the second electrical connector 200. The second locking feature 142 may automatically reset and be engaged with the second complementary locking feature 252 from the inside of the second electrical connector 200 when the first electrical connector 100 is connected in place to the second electrical connector 200, referring to FIGS. 1A, 2A, and 2C.

Optionally, the first electrical connector 100 may include a third locking feature 143, as shown in FIGS. 2E and 2F. The third locking feature 143 serves to lock the first operating member 144, in particular to lock the first operating member 144 when the first locking feature 141 is in the first locked position. The third locking feature 143 may have a third locked position and a third unlocked position. The third locking feature 143 is configured to lock the first operating member 144 when in the third locked position, such that the first locking feature 141 is retained in the first locked position, as shown in FIG. 2E. The third locking feature 143 is also configured to release the first operating member 144 when in the third unlocked position, enabling the first operating member 144 to be operable, as shown in FIG. 2F, such that the first operating member 144 may be pulled toward the right to unlock the first locking feature 141. Although the first operating member 144 is linked with the first locking feature 141 in the illustrated example, the first operating member 144 can be locked by the third locking feature 143. Accordingly, the first locking feature 141 may not be accidentally unlocked by undesired movement of the first operating member 144 under external forces caused by vibrations, such that the first electrical connector 100 may be reliably attached to the mating second electrical connector 200. Also, the first operating member 144 may be always in motion in the harsh environment, if the first operating member 144 is not locked in a desired position by the third locking feature 143. In the illustrated example, the first operating member 144 may not move frequently unless it is operated, thus prolonging its service life.

Optionally, the CPA device may include the first locking feature and the third locking feature. For example, the first electrical connector 100 may be locked to the mating electrical connector by the first locking feature. When the first locking feature is in the first unlocked position, the electrical connector 100 can be completely detached from the mating electrical connector. The first operating member can be protected from potential abnormal movement by the third locking feature, and the first locking feature can, in turn, be retained at the locked position, thereby enabling the first electrical connector 100 to be reliably connected to the mating electrical connector.

Optionally, the CPA device may include the first locking feature and the second locking feature, for locking to different sides of the second electrical connector. For example, the CPA device may not include the third locking feature. The first operating member may be retained in an initial position by a resilient member or any other suitable approach. The first locking feature may be actuated to the first unlocked position, when subjected to greater external forces along the predetermined direction. This may be achieved by replacing the third locking feature with a structure, such as spring. Comparatively, the embodiments including the third locking feature may be more reliable.

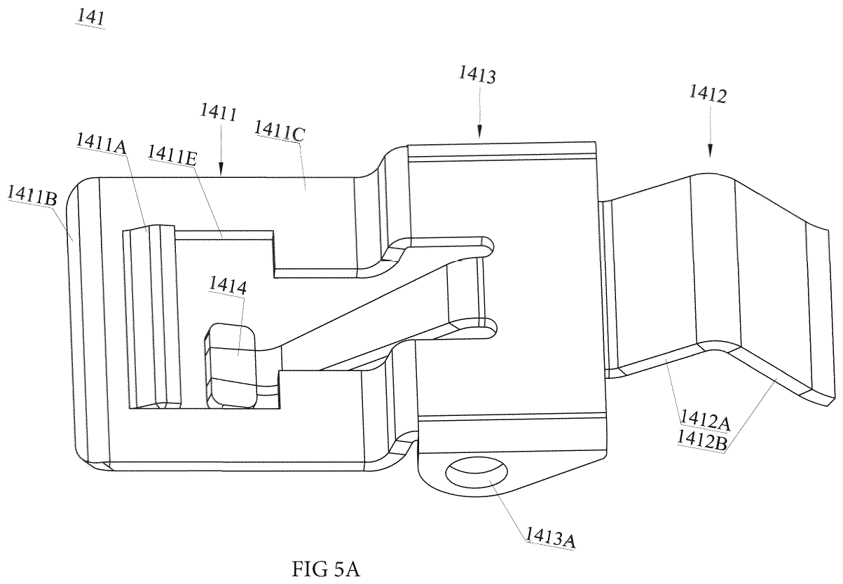

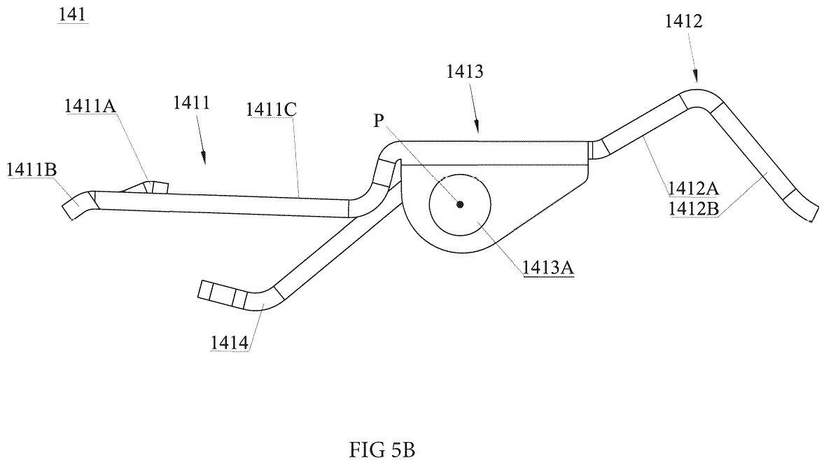

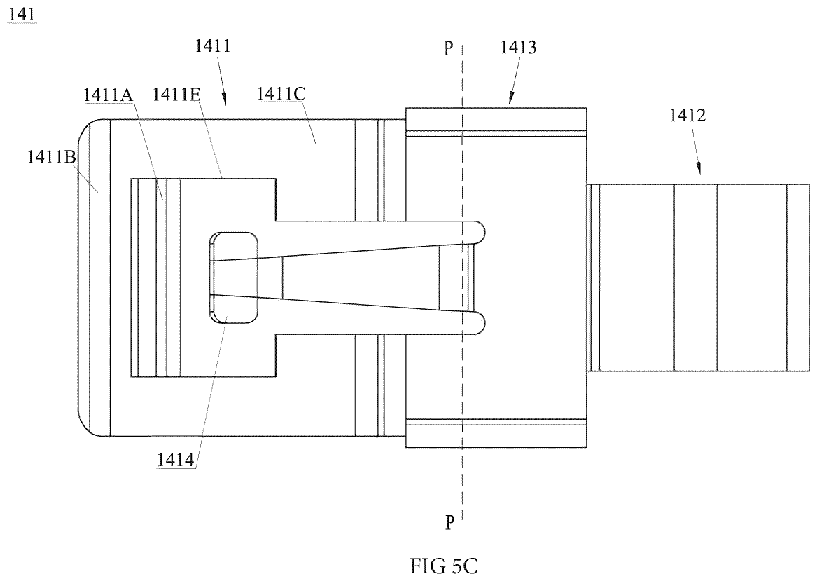

In some embodiments, as shown in FIGS. 1A, 1B, 2A and 2G, the first locking feature 141 may include a first locking head 1411 for locking with the mating second electrical connector 200, a first tail 1412 for coupling to the first operating member 144, and a first intermediate portion 1413 joining the first locking head 1411 and the first tail 1412. The first intermediate portion 1413 is pivotably connected to the housing assembly 110 about a first predetermined axis P-P (refer to FIG. 5C), such that the first locking feature 141 is pivotable between the first locked position and the first unlocked position. In some embodiments, as shown in FIGS. 5A-5B, the first intermediate portion 1413 may be provided with holes 1413A. The first predetermined axis P-P is defined by the holes 1413A and a shaft fixed to the housing assembly 110. Optionally, the shaft may be fixed to the first intermediate portion 1413 and the holes may be disposed in the housing assembly 110. When the first locking feature 141 is moved from the first locked position to the first unlocked position, the first locking head 1411 is pivoted toward the interior of the housing assembly 110. In some embodiments, the first locking head 1411 may include a protrusion, such as the hook 1411A, as shown in FIGS. 1F-1G and FIGS. 5A-5C. The first locking head 1411 may have an outer surface 1411C toward the outside of the housing assembly 110. The hook 1411A may protrude from the outer surface 1411C of the first locking head 1411. As the first electrical connector 100 are connected to the second electrical connector 200 in place, the first locking feature 141 is in the first locked position, and the hook 1411A may protrude into the first complementary locking feature 251 of the second electrical connector 200, as shown in FIG. 1F. The outer surface 1411C of the first locking head 1411 may abut against or be spaced apart from an inner surface of the second electrical connector 200. When the first electrical connector 100 is moved to the partially mated/unmated position with respect to the second electrical connector 200 along the mating direction X-X, as shown in FIG. 1G, the hook 1411A is engaged with the edge of the first complementary locking feature 251 of the second electrical connector 200, such that the first electrical connector 100 can discontinue to move along the mating direction X-X with respect to the second electrical connector 200 and stop in the partially mated/unmated position. As the first locking feature 141 is moved to the first unlocked position under the action of the first operating member 144, the first locking head 1411 is pivoted toward the interior of the housing assembly 110, and thereupon the hook 1411A can be freed from the restriction of the first complementary locking feature 251. At this point, the first electrical connector 100 is completely detached from the second electrical connector 200 by moving the first electrical connector 100 along the mating direction X-X continuously.

In some embodiments, the first locking feature 141 may be made of sheet metal. The first locking head 1411 may be elastically deformable such that the first locking head 1411 may be pivoted inwardly when the first electrical connector 100 is inserted into the second electrical connector 200. The first locking head 1411 may restore to its natural state when entering the first complementary locking feature 251.

In some embodiments, the first locking head 1411 may include a resilient beam 1414 bent toward the interior of the housing assembly 110. The resilient beam 1414 may abut against the housing assembly 110 so that the first locking head 1411 is biased toward the exterior of the housing assembly 110. In this way, the first locking feature 141 can be retained in the first locked position. In some embodiments, an opening 1411E may extend from the first intermediate portion 1413 to the first locking head 1411. The resilient beam 1414 may extend from an edge of the opening 1411E far away from the first locking head 1411. Continuously referring to FIGS. 5A-5C, the hook 1411A described above may also be disposed at another edge of the opening 1411E. In some embodiments, the hook 1411A and the resilient beam 1414 may be disposed on two opposite edges of the opening 1411E, respectively. Optionally, the opening 1411E may also be seated in the first locking head 1411. This may shorten the length of the resilient beam 1414. Optionally, there may be more than one resilient beam. As shown in FIG. 5B, the resilient beam 1414 is disposed on a side of the first predetermined axis P-P closer to the first locking head 1411. The resilient beam 1414 can apply a torque onto the first locking head 1411 around the first predetermined axis P-P toward the exterior of the housing assembly 110, as shown in FIGS. 1F to 1H, such that the first locking head 1411 is biased toward the exterior of the housing assembly 110 in its natural state and retained in the first locked position. A free end of the resilient beam 1414 may be bent away from the housing assembly 110 such that a smooth surface of the bent portion contacts the housing assembly 110. In this way, the contact surface can be increased, and the contact surface is relatively smooth, such that defects such as burrs may not be introduced by processing. The surface of the housing assembly 110 is uneasily to be scratched during the movement of the resilient beam 1414 relative to the housing assembly 110 along the mating direction X-X, thereby effectively prolonging the service life.

Optionally, the first operating member 144 may be configured to return to its initial position under the bias of the resilient beam 1414. The first operating member 144 may be locked with the third locking feature 143 at the initial position. In this way, when the first electrical connector 100 is completely detached from the second electrical connector, the first operating member 144 can automatically return to the initial position. The first operating member 144 may be designed to structurally fit with the housing assembly 110, such that a gap therebetween may be reduced when the first operating member 144 is in the initial position and foreign objects, such as the risk of dusts entering into the first electrical connector 100 to affect the service life may be reduced. Optionally, the first operating member 144 may also return to the initial position under external forces exerted by the user.

Optionally, the first locking head 1411 may have a guide 1411B at its front end. The guide 1411B may be bent in a direction opposed to the protruding direction of the hook portion 1411A. During the first electrical connector 100 mating with the second electrical connector 200, the guide 1411B may facilitate the entry of the first locking head 1411 into the second electrical connector, and the first locking feature 141 may be pivoted toward the interior of the housing assembly 110 under the guide 1411B, to ensure a smooth insertion.

In some embodiments, the first tail 1412 may have a V-shaped slot, and an opening of the V-shaped slot toward the interior of the housing assembly 110, as shown in FIGS. 1F to 1H. The first operating member 144 slides along a sidewall of the V-shaped slot to allow the first locking feature 141 to be pivoted between the first locked position and the first unlocked position. The V-shaped slot has a first sidewall 1412A and a second sidewall 1412B. The first sidewall 1412A is connected between the first intermediate portion 1413 and the second sidewall 1412B. The first operating member 144 is slidable along the second sidewall 1412B. When the first locking feature 141 is in the first locked position, a portion of the first operating member 144 that slides along the second sidewall 1412B may be located just at the deepest part of the V-shaped slot. The first tail 1412 of the first locking feature 141 may tend to be pivoted about the first predetermined axis P-P toward the interior of the housing assembly 110 under the resilient beam 1414. A distal end of the first tail 1412 may abut against the housing assembly 110 or against the first operating member 144, and thereupon the resilient beam 1414 may exert a certain pressure on the housing assembly 110 or the first operating member 144 via the distal end of the first tail 1412, such that the first locking feature 141 is retained in the first locked position. By operating the first operating member 144, for example, moving the first operating member 144 along an upward direction in the drawings, a pressure is exerted to the second sidewall 1412B of the V-shaped slot, so that the first locking feature 141 can overcome the resilience of the resilient beam 1414 and be pivoted from the first locked position to the first unlocked position around the first predetermined axis P-P. When the first operating member 144 is released, the first locking feature 141 is pivoted to the first locked position under the resilience of the resilient beam 1414, and the second sidewall 1412B of the V-shaped slot can drive the first operating member 144 back to the initial position.

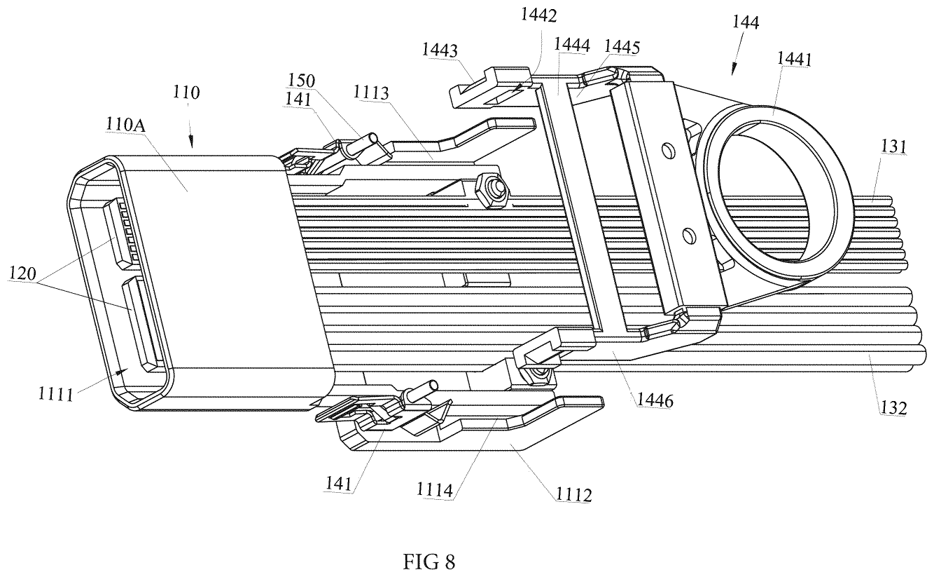

In some embodiments, the distal end of the first tail 1412 may abut against the housing assembly 110, rather than the first operating member 141, when the first locking feature 141 is in the first locked position. It should be appreciated that if the distal end of the first tail 1412 abuts against the first operating member 144, the distal end of the first tail 1412 may scrape the surface of the first operating member 144 when the first operating member 144 is actuated relative to the first tail 1412 along the mating direction X-X, such that the first operating member 144 may be worn severely where the distal end of the first tail 1412 is rough. In comparison, the first tail 1412 would not move relative to the housing assembly 110 along the mating direction X-X. It is easier to provide a first operating member 144 with an opening 1442, as shown in FIG. 8, through which the first tail 1412 passes to contact with the housing assembly 110. In this way, the first operating member 144 is avoided from scratching, and the costs can be substantially reduced. Moreover, a pillar 1443 formed between the opening 1442 and the end of the first operating member 144 is just able to serve as the portion of the first operating member 144 that slides on the second sidewall 1412B. The pillar 1443 will be discussed in more detail hereinafter.

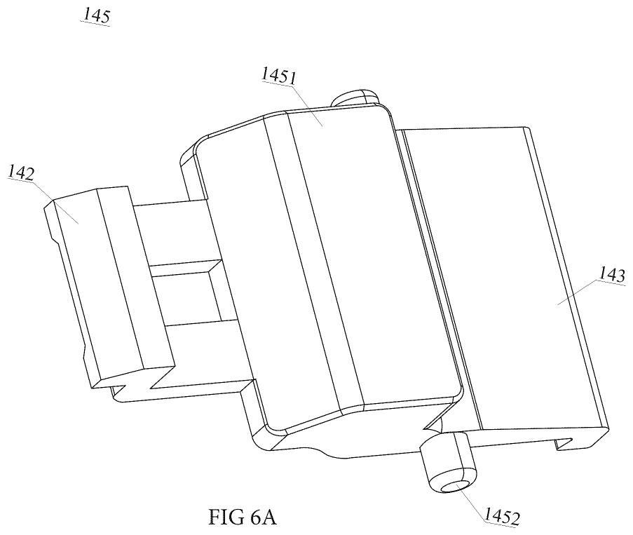

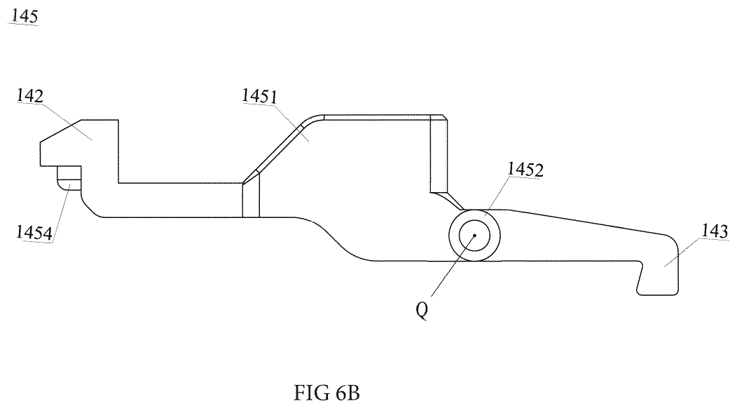

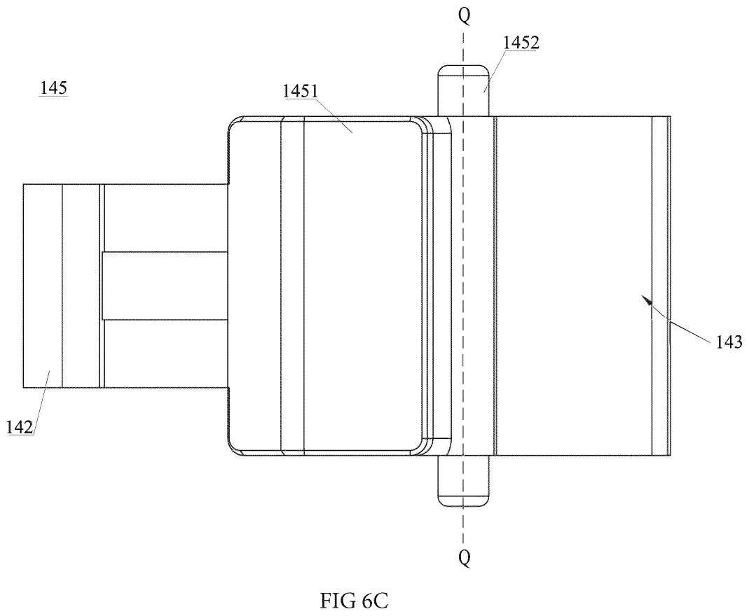

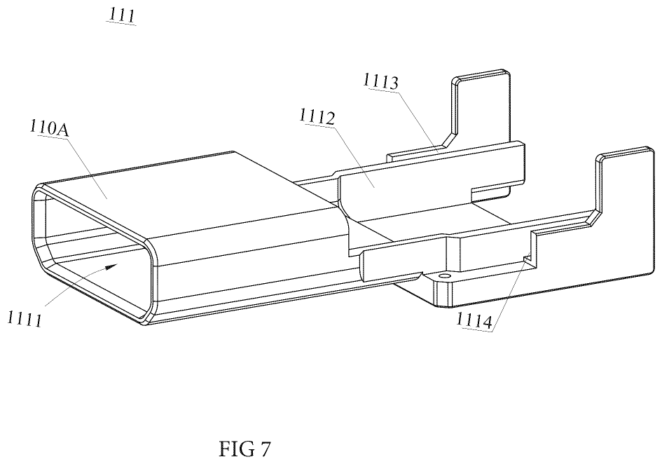

In some embodiments, the CPA device may also include a second operating member 145, as shown in FIGS. 2E and 2F, and FIGS. 6A to 6C. An intermediate portion of the second operating member 145 is pivotably connected to the housing assembly 110 about a second predetermined axis Q-Q, and the second locking feature 142 and the third locking feature 143 are located at opposite ends of the second operating member 145, respectively. In some embodiments, the second operating member 145 may include a pressing portion 1451. The pressing portion 1451 may pass through the housing assembly 110 to be externally operable. The pressing portion 1451 may be disposed between the second predetermined axis Q-Q and the second locking feature 142. In some embodiments, the second operating member 145 may be a member integrally molded with the second locking feature 142 and the third locking feature 143, or manufactured separately and then joined with the second locking feature 142 and the third locking feature 143. The pressing portion 1451 may protrude beyond the surface of the housing assembly 110 of the first electrical connector 100 for easy operation. Referring back to FIGS. 2B and 2C, the second locking feature 142 may protrude beyond the outer surface of the housing assembly 110 when in the second locked position, so that the second locking feature 142 can be engaged with the second electrical connector 200. When the pressing portion 1451 may be pressed, as shown in FIG. 2C, the second locking feature 142 is moved into the housing assembly 110 to reach the second unlocked position. In some embodiments, as shown in FIGS. 6A to 6D, the second operating member 145 may be provided with second shafts 1452 concentric with the second predetermined axis Q-Q, such that the second operating member 145 is pivotably connected to the housing assembly 110 via the second shafts 1452.

The pressing portion 1451 is pivotable in the same direction as the first locking feature 141 and in an opposite direction to the third locking feature 143. When the second locking feature 142 is in the second locked position, the third locking feature 143 is in the third locked position, as shown in FIG. 2E. When the pressing portion 1451 is pressed, the second locking feature 142 is pivoted downwardly to the second unlocked position and disengaged from the second electrical connector, such that the first electrical connector 100 is unlocked by the second locking feature 142. At the same time, the third locking feature 143 is pivoted upwardly to reach the third unlocked position. For example, when the second locking feature 142 is in the second locked position, the third locking feature 143 is in the third locked position; and when the second locking feature 142 is in the second unlocked position, the third locking feature 143 is in the third unlocked position. For example, the second locking feature 142 and the third locking feature 143 may synchronously move between respective locked and unlocked positions. In this way, the second locking feature 142 and the third locking feature 143 can be unlocked by use of the pressing portion 1451 on the second operating member 145, without an additional unlocking operating member.

In some embodiments, a resilient member 160 may be provided between the second operating member 145 and the housing assembly 110, for biasing the second locking feature 142 toward the second locked position. It should be appreciated that, when the pressing portion 1451 does not protrude beyond the surface of the housing assembly 110, it may be difficult to manually restore the pressing portion 1451 to its original position after it is pressed. In order to reliably lock the first electrical connector 100 to the mating electrical connector, the second locking feature 142 may be biased toward the second locked position in a natural state. The second locking feature may be maintained in the second locked position by the resilient member 160 and the pressing portion 1451 is protruding for easy operation. The resilient member 160 may include any suitable part, such as resilient sheet, spring. In some embodiments, a magnetic force may be applied onto the second locking feature 142 for biasing. In some embodiments, the resilient member 160 may be disposed corresponding to the second locking feature 142. Thus, the resilient force generated by the resilient member 160 may act directly on the second locking feature 142, ensuring that the second locking feature 142 is reliably in the second locked position. In some embodiments, the second operating member 145 may be provided with a first positioning post 1454, the housing assembly 110 may be provided with a second positioning post 115, and two ends of the resilient member 160 may be sleeved onto the first positioning post 1454 and the second positioning post 115, respectively.

In some embodiments, the predetermined direction along which the first operating member 144 is operable may be perpendicular to the second predetermined axis Q-Q. In the illustrated example, the second predetermined axis Q-Q may be parallel to the first lateral direction Y-Y, and the predetermined direction may be parallel to the mating direction X-X. The housing assembly 110 may have sufficient space in the first lateral direction Y-Y to accommodate the second operating member 145 pivotable about the second predetermined axis Q-Q, and it is more advantageous for the third locking feature 143 of the second operating member 145 to lock the movement perpendicular to the second predetermined axis Q-Q. It should be appreciated that, once the first operating member 141 is applied a force in the predetermined direction parallel to the mating direction X-X, and the force may be conducted to the second operating member 145 via the third locking feature 143. The force on the second operating member 145 is perpendicular to the second shafts 1452 thereof, and therefore the second shafts 1452 can spread the force to the housing assembly 110 without causing the second operating member 145 to be twisted. If the predetermined direction is parallel to the second predetermined axis Q-Q, the force applied onto the first operating member 144 and in turn onto the second operating member 145 in operation may be not perpendicular to the second shafts 1452, which may result in deformations of the second shafts 1452 and/or a portion of the housing assembly 110 for accommodating the second shafts 1452. Accordingly, the second operating member 145 may be loose. In addition, when the second locking feature 142 on the second operating member 145 is locked to the mating electrical connector and the predetermined direction is parallel to the mating direction X-X, if a pulling force is applied onto the first operating member 144, the second shafts 1452 can withstand a part of the pulling force conducted to the second operating member 145, and the second locking feature 142 can withstand another part of the pulling force, allowing for more reliable locking.

In some embodiments, the second locking feature 142 may be retained in the second unlocked position by the mating electrical connector during the partial mating/unmating of the first electrical connector 100. In some narrower environments, the user is able to detach the first electrical connector 100 with one hand. In these applications, the user is typically complete one action at a time. If the second operating member 145 automatically returns to its original position after being operated, causing the second locking feature 142 and the third locking feature 143 to be re-locked after being unlocked, the user cannot continue to operate the first operating member 144 to detach the first electrical connector 100 from the mating second electrical connector 200. As shown in FIG. 1B, the user may press the second operating member 145 as well as pull out the first electrical connector 100 along the mating direction X-X, so as to move the first electrical connector 100 to the partially mated/unmated position. At this point, the second locking feature 142 is blocked by the mating electrical connector and cannot restore to the second locked position. Therefore, the user may then operate the first operating member 144 to completely detach the first electrical connector 100 from the second electrical connector 200, and no longer operate the second operating member 145. Thus, the operating difficulty can be obviously reduced based on the above technical solution, so that the first electrical connector 100 can be applied to a variety of complex and narrow environments.

In some embodiments, the plurality of conductive pads 122 on the circuit board 120 may be dimensioned to maintain electrical contact with the mating electrical connector during the partial mating/unmating of the first electrical connector 100. As described above, it is undesirable that the first electrical connector 100 and the mating electrical connector are accidentally disconnected by external forces. Even if the second locking feature 142 fails due to external factors, such as bumps and collisions, which cause the first electrical connector 100 to reach the partially mated/unmated position, at least the most basic function can be ensured. In some embodiments, the lengths of the circuit board 120 and the conductive pads 122 thereon may compensate for a distance between the mated position and the partially mated/unmated position, such that at least a part of conductors of the electrical connector 100 can remain electrically connected to the mating electrical connector. Optionally, the length of some of the conductive pads on the circuit board is slightly shorter than that of the others, and the shorter conductive pads can be disconnected electrically from the mating electrical connector during the partial mating/unmating, while the other longer conductive pads are retained electrically connected. The longer conductive pads may be connected to circuits for dedicatedly detecting the disconnection of the electrical connectors, and/or be multiplexed by a part of conductive pads for the ground cables for shielding, and/or be connected to some data cables. Power and/or signals between the devices employing the electrical connectors may not be completely interrupted at the partially mated/unmated stage of the electrical connectors. The devices may detect the partial mating/unmating of the electrical connectors, and thus issue an alarm or perform other operations.

In some embodiments, the housing assembly 110 may include a first housing 111 and a second housing 112 fastened onto the first housing 111, as shown in FIGS. 2A, 2G, and 2H. The first locking feature 141 and the first operating member 144 may be mounted between the first housing 111 and the second housing 112. The first housing 111 and the second housing 112 may be processed by injection molding, respectively. In this way, molds for the first housing 111 and the second housing 112 can become simpler in structure, production and design costs can be reduced, and yields may be improved. Moreover, the difficulty of assembling the first locking feature 141 and the first operating member 144 can be reduced.

In some embodiments, the first locking feature 141 is pivotably connected between the first housing 111 and the second housing 112 through a first shaft 150. The first shaft 150 passes through the first locking feature 141. Two ends of the first shaft 150 are inserted to the first housing 111 and the second housing 112, respectively. As described above, the first locking feature 141 may include the holes 1413A. The first shaft 150 may pass through the holes 1413A (in FIG. 5) and the diameter of the holes 1413A may be slightly larger than that of the first shaft 150, such that the first locking feature 141 may be pivoted around the first shaft 150 with less resistance. In some embodiments, the first shaft 150 may also fit closely with the holes 1413A, and the first shaft 150 and the first locking feature 141 may be pivoted together. In some embodiments, the first shaft 150 may be made of a material with plasticity, such as an aluminum tube. When the first shaft 150 is not required to be pivoted together with the first locking feature 141, the ends of the first shaft 150 may be fixed to the first housing 111 and the second housing 112 by interference fit or fasteners, etc. The ends of the first shaft 150 may be squeezed and expanded so as to increase their diameters, such that the ends cannot be divorced from the apertures of the first housing 111 and the second housing 112. The first housing 111 and the second housing 112 may be fixed to each other.

In some embodiments, there may be a pair(s) of the first locking features 141 disposed on opposite sides of the first housing 111 and the second housing 112 in the first lateral direction Y-Y perpendicular to the predetermined direction. The first locking features 141 each is mounted between the first housing 111 and the second housing 112 through the respective first shaft 150. The first electrical connector 100 may be mated with the second electrical connector 200 with one pair of the first locking features 141. When the first electrical connector 100 is subjected to external forces along the first lateral direction Y-Y, at least one of the first locking features 141 can withstand the external forces. The first electrical connector 100 may not tilt which may cause misalignment of the conductive pads 122. Moreover, the pair of the first locking features 141 may also share the external forces applied on the end of the first housing 111 inserted into the second electrical connector 200, and the end of the first housing 111 may not break. One of the first locking features 141 is shown in FIGS. 5A to 5C, and the other one is a mirror image of the first locking features 141 shown in the drawings. This makes the design less difficult and the external forces are evenly dispersed. However, the present disclosure also does not exclude embodiments in which the first locking features have different structures and are not mirror images of each other.

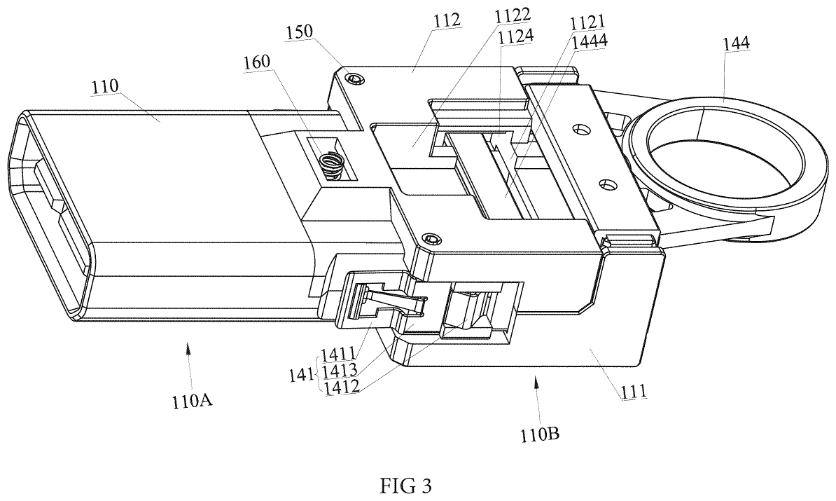

In some embodiments, the aforementioned first mating portion 110A for mating with the mating electrical connector may be formed by the first housing 111, and the first housing 111 may include a first cable connection portion 1112. In some embodiments, the shape of the first mating portion 110A may be tubular, and the cross-section thereof may be a circle, an oval, or a rounded rectangle, etc. An outer surface of the first mating portion 110A may be smooth, without sharp edges or sharp corners, making it safer for the user. The first mating portion 110A may match a mating portion (e.g., a second mating portion described below) of the mating electrical connector in shape, such that the first electrical connector 100 can be precisely positioned relative to the mating electrical connector even subjected to external forces or vibrations. The first mating portion 110A may include a first mounting channel 1111, as shown in FIGS. 2A, 2G and 8. The circuit board 120 may be fixed inside the first mounting channel 1111. The second housing 112 is fastened onto the first cable connection portion 1112 and forms a second mounting channel with the first cable connection portion 1112. The plurality of high-speed data cables 131 pass through the second mounting channel. The first operating member 144 is limited by the first housing 111 and the second housing 112 to be slidably connected to the second mounting channel along the predetermined direction. As shown in FIG. 3, an upper surface of the first operating member 144 may abut against an inner wall of the second housing 112, and a lower surface of the first operating member 144 may abut against an inner wall of the first housing 111, thereby positioning the first operating member 144 along the second lateral direction Z-Z. The circuit board 120 may be fixed inside the first mounting channel 1111 by a module housing 170, as shown in FIGS. 2G and 4A. The module housing 170 may be molded on the circuit board 120 and may have a certain degree of resilience. When the first electrical connector 100 is connected to the mating electrical connector, the module housing 170 may undergo an appropriate deformation, to reduce the risk of the circuit board 120 being damaged if the circuit board 120 is forcibly inserted into the mating electrical connector.

In some embodiments, the first mating portion 110A and the first cable connection portion 1112 may be opposite along the predetermined direction, which may be parallel to the mating direction X-X. When the user expects to unlock the first electrical connector 100, the first operating member 144 is moved relative to the housing assembly 110 along the predetermined direction, and the first electrical connector 100 can be detached from the mating electrical connector by continuing to move the first operating member 144. It can be simple and convenient to achieve with one hand. The first mating portion 110A and the first cable connection portion 1112 are opposite along a straight line, and thus there is no need to bend the cables. Accordingly, the structure is simpler and production and assembly costs are lower.

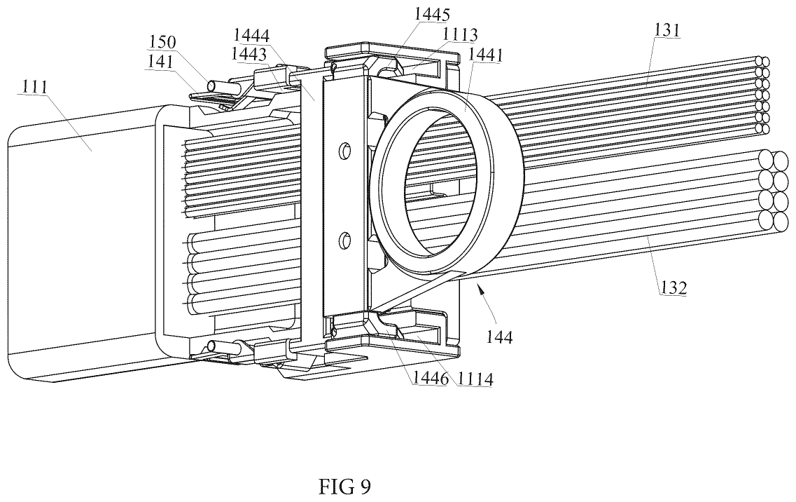

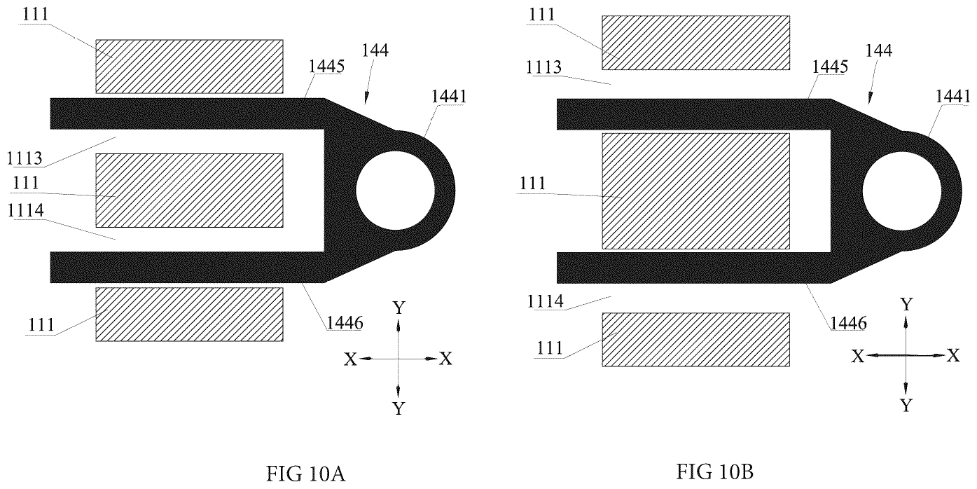

In some embodiments, as shown in FIGS. 2G and 8, the first housing 111 may include a first slot 1113 and a second slot 1114 extending along the predetermined direction (e.g., the mating direction X-X) and spaced apart along the first lateral direction Y-Y. The first operating member 144 may include a first arm 1445 and a second arm 1446 slidably inserted into the first slot 1113 and the second slot 1114, respectively. As shown in FIGS. 8 and 9, the first arm 1445 and the second arm 1446 of the first operating member 144 may extend along the mating direction X-X. The first slot 1113 and the second slot 1114 may be integrally molded in the first housing 111. The spacing between the first slot 1113 and the second slot 1114 matches with the spacing between the first arm 1445 and the second arm 1446, and the width (e.g., the dimension in the first lateral direction Y-Y) of the first slot 1113 may be slightly larger than the width of the first arm 1445 such that a fit-up gap may be reserved between the two, the dimension of the fit-up gap may be 0.1-0.5 mm. Similarly, the width of the second slot 1114 may be slightly larger than the width of the second arm 1446, so that the second arm 1446 can slide easily inside the second slot 1114 and not swing in the second slot 1114. In some embodiments, to facilitate mounting of the first arm 1445 and the second arm 1446, the first slot 1113 and the second slot 1114 may extend to the surface of the first housing 111 facing the second housing 112. After the second housing 112 is fastened to the first housing 111, the first arm 1445 and the second arm 1446 may be limited so that they can slide along the first slot 1113 and the second slot 1114, respectively. In some embodiments, the first arm 1445 and the second arm 1446 can be kept in respective positions, in the case that the first housing 111 has a greater rigidity. The widths of the first slot 1113 and the second slot 1114 may not match the widths of the first arm 1445 and the second arm 1446, respectively. As shown in the example illustrated in FIG. 10A, outer side surfaces of the first arm 1445 and the second arm 1446 opposed in the first lateral direction Y-Y may respectively abut against two sidewalls of the first slot 1113 and the second slot 1114 that are proximate to the outer surface of the first housing 111, whereas inner side surfaces of the first arm 1445 and the second arm 1446 facing to each other may respectively have gaps from the sidewalls of the first slot 1113 and the second slot 1114. The first operating member 144 may not swing inside the first housing 111. FIG. 10B illustrates another example in which the inner side surfaces of the first arm 1445 and the second arm 1446 facing to each other along the first lateral direction Y-Y may respectively abut against the two sidewalls of the first slot 1113 and the second slot 1114 that are proximate to the inside of the first housing 111, whereas the outer side surfaces of the first arm 1445 and the second arm 1446 may be spaced apart from the sidewalls of the first slot 1113 and the second slot 1114. This also enables the first operating member 144 to be stable. The above two examples may require less precision in the machining of the first slot 1113 and the first arm 1445, as well as the second slot 1114 and the second arm 1446, so as to reduce costs.

The spacing between the first arm 1445 and the second arm 1446 may be larger, such that the first arm 1445 and the second arm 1446 may be positioned at the locations near the outer surface of the first housing 111. When the first operating member 144 is subjected to external forces in the first lateral direction Y-Y, the larger spacing may serve to spread the forces more evenly across the first housing 111, reducing the risk of deformation of the first operating member 144 and the first housing 111. In some embodiments, the sidewalls of the first slot 1113 and the second slot 1114 should have sufficient thickness, thereby ensuring the structural strength of the first slot 1113 and the second slot 1114. On this basis, the spacing between the first arm 1445 and the second arm 1446 may be as large as possible, so as to respectively match with the first arm 1445 and the second arm 1446 which are spaced apart at a larger distance. Moreover, the space between the first arm 1445 and the second arm 1446 may also allow the high-speed data cables 131 and the power cables 132 to be mentioned below to pass through, and/or be used to house the third locking feature 143 and the second operating member 145, etc.

Optionally, the first slot 1113 and the second slot 1114 may also be formed in the second housing 112, or formed by both the first housing 111 and the second housing 112.

Ends (referred to as coupling ends) of the first arm 1445 and the second arm 1446 toward the first mating portion 110A are coupled to the first locking features 141, such that the first locking features 141 are movable between the respective first locked position and first unlocked position. The coupling ends of the first arm 1445 and the second arm 1446 may protrude beyond the first slot 1113 and the second slot 1114, respectively, to couple to the first locking features 141 on both sides, respectively.

The first operating member 144 may also include a first operating portion 1441, connected between ends of the first arm 1445 and the second arm 1446 opposite the first mating portion 110A. The first operating portion 1441 extends beyond the housing assembly 110. In some embodiments, the first operating portion 1441 may be a handle that can be operated or pulled by a user. The first operating portion 1441 may be a pull tab with an aperture for receiving the user's finger or a tool. The user can operate the first operating member 144 along the predetermined direction by passing the finger or tool through the aperture. Compared with embodiments in which the first operating member is moved by friction from fingers, the first operating portion 1441, e.g., a pull tab, may be less prone to slippage, and the user can easily operate the first operating member 1441 even if there are snags. The first operating portion 1441 may be integrally processed with the first operating member 144 by the same material in molding process. The first operating portion 1441 may also made by a different material from the rest of the first operating member 144. In this case, the first operating portion 1441 may be made of resilient materials, such as rubber, and mounted onto the first operating member 144 by a suitable method such as gluing, fusing, fastener. The first operating portion 1441 may be over-molded onto the first operating member 144. The first operating portion 1441 in a resilient material can effectively improve the user experience during operation.

The user may pull the first operating portion 1441 outwardly along the predetermined direction, e.g., the mating direction X-X. The first operating portion 1441 may translate along the predetermined direction under the guidance of the first slot 1113 and the second slot 1114. With reference to FIGS. 1F to 1H and FIGS. 8 to 9 in combination, a coupling end of the first arm 1445 may include the pillar 1443 mated with the V-shaped slot of the first tail 1412. The pillar 1443 operates the first locking feature 141 by sliding along the second sidewall 1412B of the V-shaped slot. The surface of the pillar 1443 contacting with the second sidewall 1412B may be curved to minimize frictional resistance. The first locking feature 141 returns to the first locked position under the resilient beam 1414 when the first operating member 144 is released, and the inclined surface of the V-shaped slot may apply pressure to the pillar 1443, causing the first operating member 144 to return to the initial position.

In some embodiments, the first operating member 144 may include a crossbeam 1444, which is connected between middle portions of the first arm 1445 and the second arm 1446, as in FIG. 2G and FIGS. 8 to 9. The third locking feature 143 may hook onto the crossbeam 1444 when in the third locked position, referring to FIGS. 2E and 2F. As described above, the first locking feature 141 may be unlocked by operating the first operating member 144. In some embodiments, the third locking feature 143 may be in the shape of a hook. In some embodiments, the third locking feature 143 may be hooked at the middle of the crossbeam 1444 to uniformly apply a force to position the first operating member 144, which in turn maintains the first locking feature 141 in the first locked position. Additionally, the mechanical strength of the first operating member 144 may also be enhanced by the crossbeam 1444 connected between the first arm 1445 and the second arm 1446.

In some embodiments, the housing assembly 110 may include an opening 1121, for example, formed in the inner surface of the second housing 112, as shown in FIG. 3. When the second housing 112 is mounted onto the first housing 111, the crossbeam 1444 may pass through the opening 1121 to limit the sliding range of the first operating member 144. As described above, the second sidewall 1412B of the V-shaped slot of the first locking feature 141 can apply pressure to the pillar 1443 of the first operating member 144 under the force from the resilient beam 1414 when the first operating member 144 is released by the user, so that the first operating member 144 returns to its initial position. The risk of the pillar 1443 escaping from the V-shaped slot can be reduced and the first operating member 144 may not be moved too far to cause damages to the first locking feature 141 by limiting the first operating member 144 in the sliding range.

In some embodiments, the housing assembly 110 may comprise a third housing 113, which may be fastened onto the second housing 112. The second operating member 145 is mounted between the second housing 112 and the third housing 113. The second housing 112 may be provided with an aperture 1123, as shown in FIGS. 2G and 2H, and the second locking feature 142 passes through the aperture 1123 and protrudes beyond the outer surface of the second housing 112. The third locking feature 143 is disposed on the inner side of the third housing 113. As shown in FIG. 2H, the third housing 113 may be provided with a snap 1131. The third housing 113 may be mounted to the second housing 112 along the second lateral direction Z-Z. The snap 1131 may be resiliently deformed and be engaged with a recess of the second housing 112. The second housing 112 may be provided with a snap slot 1124 to engage with the snap 1131. For example, the snap 1131 may include a flat surface 1131A parallel to the first lateral direction, and a guide bevel 1131B. The guide bevel 1131B may allow the third housing 113 to easily enter into the snap slot 1124 of the second housing 112, while the flat surface 1131A is engaged with the snap slot 1124, such that the third housing 113 is fastened to the second housing 112. After the assembly of the first housing 111 and the second housing 112, the third locking feature 143 may be placed into a desired position through a mounting opening 1122 of the second housing 112. Then, the mounting opening 1122 of the second housing 112 is closed by the third housing 113, such that the risk of foreign objects falling into the mounting opening 1122 of the second housing 112 to cause failure of the third locking feature 143 may be reduced. Optionally, the third locking feature 143 may also be limited in the desired position by the third housing 113.

In some embodiments, as described above, the second shafts 1452 may be provided on two sides of the intermediate portion of the second operating member 145, respectively. In some embodiments, a rod may be inserted into holes in the second operating member 145 and the ends of the rod protrude from the side surfaces of the second operating member 145 to form the second shafts 1452. The second shafts 1452 may be integrally molded with the second operating member 145. Holes are encircled by the second housing 112 and the third housing 113 together, and the second shafts 1452 are inserted into the holes, respectively. In some embodiments, referring to FIGS. 2G and 3, the second housing 112 may include first cuts 1125, and the third housing 113 may include second cuts 1132. The openings of the first cuts 1125 and the second cuts 1132 may face to each other, such that they may form the holes. As described above, the third locking feature 143 may be mounted into the second housing 112 through the mounting opening 1122. In the case that the third locking feature 143 is provided on the second operating member 145, the second operating member 145 may be mounted in place through the mounting opening 1122. The holes are formed for limiting the second shafts 1452 after the third housing 113 is mounted to the second housing 112, such that the second operating member 145 is assembled easily. In this way, the second operating member 145 is pivotable around the second shafts 1452.

In some embodiments, the housing assembly 110 may include a strain relief member 114, as shown in FIGS. 2G, 2H, and 2I, the strain relief member 114 may be connected to the second housing 112 and spaced apart from the first shaft 150 along the predetermined direction. A portion of the first housing 111 is clamped between the second housing 112 and the strain relief member 114. As described above, the first housing 111 and the second housing 112 may be fixed to each other by the first shaft 150. When the first shaft 150 is close to one end of the first housing 111 and/or that of the second housing 112, when their other ends are subject to external forces, the first shaft 150 may withstand a larger strain which may result in damages to one or more of the first housing 111, the second housing 112, and the first shaft 150. The strain relief member 114 may be fixed to the end of the second housing 112 away from the first shaft 150 by any suitable means, such as fasteners, snap, to relieve the strain. As shown in FIG. 21, the strain relief member 114 may include a cross member 1141 which may apply a force in a second lateral direction Z-Z to a portion of the first housing 111, such that the first housing 111 is pressed against the second housing 112. The strain relief member 114 may include a break 1142. As the strain relief member 114 is mounted to the first housing 111 and the second housing, the break 1142 forms a channel together with the inner wall of the second housing 112. High-speed data cables 131 and/or power cables 132 may pass through the channel. The high-speed data cables 131 are more tensile on their own than where the high-speed data cables 131 connect to the circuit board 120, and so does the power cables 132. The strain relief member 114 may also cooperate with the second housing 112 to clamp the high-speed data cables 131 and/or the power cables 132 tightly, such that the high-speed data cables 131 and/or the power cables 132 are protected from separating from the circuit board 120 when they are subjected to excessive pulling forces.

In some embodiments, the second housing 112 may be embedded with a nut, and a fastener passes through the strain relief member 114 and is threaded to the nut to secure the strain relief member 114 to the second housing 112. Where the second housing is made of thermoplastics, the nut may be a knurled nut, embedded into the second housing 112 by heating. The nut may also be secured into a recess reserved in the second housing 112, for example by adhesives, the second housing 112 may be over-molded on the nut. In this way, the nut may be enclosed and unlikely to fall during disassembly and/or assembly, and the appearance is cleaner. The process can be simplified and the nut is firmly fixed to the second housing 112. The nut may be made of a metallic material to avoid problems, such as stripped thread.

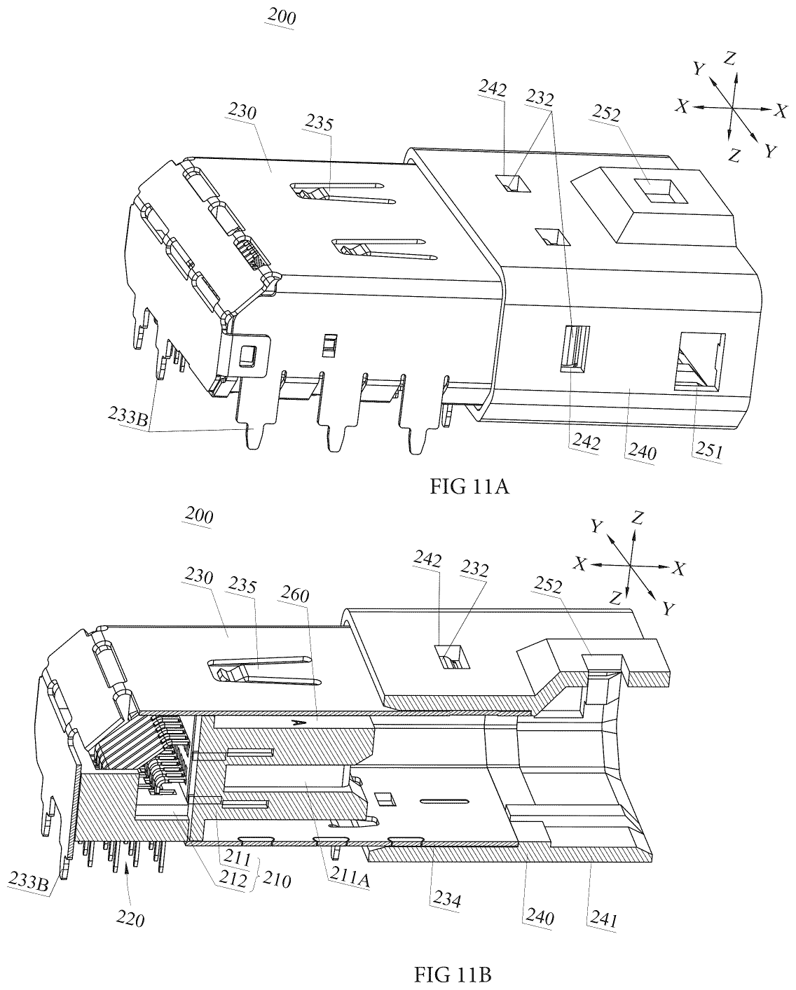

According to another aspect of the present disclosure, a second electrical connector 200 is provided. The second electrical connector 200 may, for example, be mated to the first electrical connector 100 described above. The second electrical connector 200 is used to establish an electrical connection between a to-be-mounted circuit board (not shown) and a mating electrical connector. As shown in FIGS. 11 to 14, the second electrical connector 200 may be configured as a socket connector. For example, the to-be-mounted circuit board may be called as a first circuit board (which may also be referred to as a “first printed circuit board” or “first PCB”), and the mating first electrical connector 100 may be a plug connector. The second electrical connector 200 may be mounted to the to-be-mounted circuit board. Conductive members of the plug connector may be inserted into the second electrical connector 200, such that the to-be-mounted circuit board may be interconnected with the plug connector via the second electrical connector 200.

Optionally, the second electrical connector 200 may also be mated with another electrical device, which may be a second circuit board (which may also be referred to as a “second printed circuit board” or “second PCB”). In this case, the first circuit board may be a motherboard, and the second circuit board may be a daughter card, such as solid state disk (SSD), wireless communication module, RF module. The electrical connector may be mounted to the first circuit board, and conductive pads on the second circuit board may be inserted into the electrical connector, such that the first circuit board and the second circuit board may be interconnected via the electrical connector.

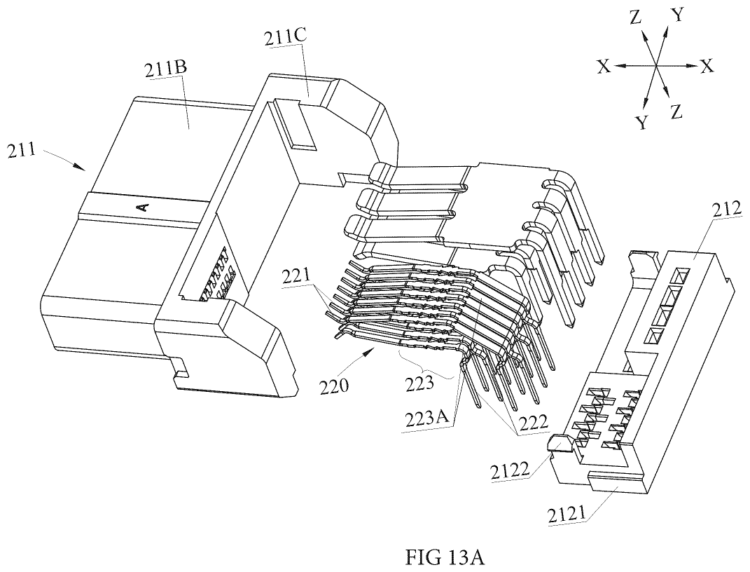

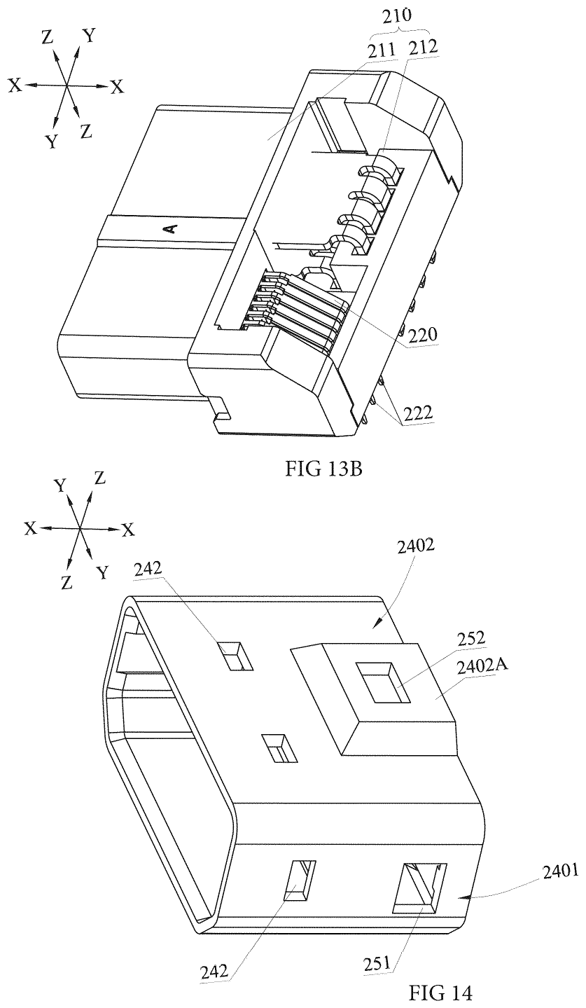

As shown in FIGS. 13A and 13B, the second electrical connector 200 may comprise a main housing 210, which include a second mating portion 211 for mating with the mating electrical connector. The main housing 210 may be molded with an insulating material, such as plastic. Plastic may include but not limited to liquid crystal polymer (LCP), polyphenylene sulfite (PPS), high-temperature nylon or poly-p-phenylene oxide (PPO), or polypropylene (PP), or other materials may be used. The second electrical connector 200 is configured as a socket connector. For clear and concise description, the mating direction X-X, the first lateral direction Y-Y and the second lateral direction Z-Z are in use hereinafter.

The second electrical connector 200 may include a plurality of conductive terminals 220. The plurality of conductive terminals 220 may be held by the main housing 210 and extend from the second mating portion 211 to a second mounting portion 212. The plurality of conductive terminals 220 each may include a mating end 221, a mounting end 222 opposite the mating end 221, and an intermediate portion 223 extending between the mating end 221 and the mounting end 222. The plurality of conductive terminals 220 may be formed of conductive materials including metal or metal alloy, such as copper or a copper alloy. The mating end 221 may be configured for mating with a corresponding conductive portion of an electrical device such as the aforementioned second circuit board or plug connector, and the mounting end 222 may be configured to be mounted to a circuit board such as the aforementioned first circuit board. The mounting end 222 may be straight along the second lateral direction Z-Z. For example, the first circuit board may include conductive portions such as conductive pads or conductive through-holes, and the mounting ends 222 of the conductive terminals 220 may be configured to be connected to the conductive portions of the first circuit board by any suitable process known in the art (e.g., press-fit or soldering). For example, the second circuit board may include conductive portions disposed at or near an edge thereof and the conductive portions may be inserted into the electrical connector, such that the conductive portions of the second circuit board electrically contact with the mating ends 221 of the conductive terminals 220. In this manner, the conductive terminals 220 can establish electrical connections between the first circuit board and the second circuit board, to transmit signal and/or power. As another example, the plug connector may include a circuit board, such as the circuit board 120, disposed in the first mating portion, and the pads of the circuit board are in contact with the mating ends 221 of the conductive terminals 220. In this manner, the conductive terminals 220 can establish electrical connections between the first circuit board and the plug connector, to transmit signal and/or power.

As illustrated in FIG. 13A, the intermediate portion 223 of each of the plurality of conductive terminals 220 may include a curved portion, such that the mounting end 222 and the mating end 221 of the conductive terminal 220 are oriented substantially perpendicular to each other. The mounting ends 222 are oriented along the second lateral direction Z-Z, and the mating ends 221 are oriented along the mating direction X-X. With this configuration, the second electrical connector 200 can be mounted to the first circuit board perpendicular to the second lateral direction Z-Z and be mated with the plug connector or the second circuit board along the mating direction X-X so that the first circuit board is electrically connected to the plug connector or the second circuit board.

During the mounting of the second electrical connector 200 onto the first circuit board, and/or during the insertion/detachment of the plug connector into/from the second electrical connector 200 which is already mounted onto the first circuit board, it is prone to occur that parts of the intermediate portions 223 of the conductive terminals 220 adjacent to the mounting ends 222 are bent or even broken, since the intermediate portions 223 of the conductive terminals 220 are curved. In order to avoid such problems, the main housing 210 may include a second mounting portion 212. The second mounting portion 212 may be secured to the second mating portion 211, as shown in FIG. 13A. The second mounting portion 212 may include a protrusion 2121 and a latch 2122. The protrusion 2121 may limit relative movement direction between the second mounting portion 212 and the second mating portion 211, and the latch 2122 may determine the position of the second mounting portion 212 relative to the second mating portion 211. After the second mounting portion 212 is secured to the second mating portion 211, the second mounting portion 212 may surround and hold at least parts of the intermediate portions 223 between curved portions 223A and the mounting ends 222.

With this configuration, when the second electrical connector 200 is mounted to the first circuit board and/or when the plug connector is inserted into/detached from the second electrical connector 200 which is already mounted onto the first circuit board, the parts of the intermediate portions 223 adjacent to the mounting ends 222 (e.g., parts of the intermediate portions between the curved portions 223A and the mounting ends 222) cannot tilt relative to the second lateral direction Z-Z, such that the parts of the intermediate portions 223 adjacent to the mounting ends 222 can be efficiently avoided from bending or even breaking. The second electrical connector 200 has a higher mechanical reliability. Moreover, the second mounting portion 212 is also capable of keeping the conductive terminals 220 in place relative to the main housing 210.

The mating end 221 of each conductive terminal may be configured to be inserted into the second mating portion 211 from a rear side along the mating direction X-X. At least a part of the intermediate portion 223 between the mating end 221 and the curved portion 223A may be held by the second mating portion 211 to keep the conductive terminal in place relative to the insulating housing. For example, at least the part of the intermediate portion 223 between the mating end 221 and the curved portion 223A may include a barb, for engaging with a wall of a channel formed in the second mating portion 211. The second mating portion 211 may include a groove 211A recessed from a surface of the second mating portion 211 facing the mating first electrical connector 100 along the mating direction X-X. The groove 211A is configured to receive conductive portions of the electrical device. The mating ends 221 of the plurality of conductive terminals 220 are exposed in the groove 211A to electrically connect with the conductive portions of the electrical device respectively when the conductive portions are inserted into the groove 211A. The conductive terminals 220 are able to be in place relative to the main housing 210 by the second mounting portion 212 surrounding and holding at least parts of the intermediate portions 223 of the conductive terminals 220 between the curved portions 223A and the mounting ends 222 as well as by the second mating portion 211 holding at least parts of the intermediate portions 223 between the mating ends 221 and the curved portions 223A. It should be appreciated that the present application is not limited thereto.

In some embodiments, the second mating portion 211 is substantially perpendicular to the second mounting portion 212, since the mating ends 221 of the conductive terminals 220 held by the second mating portion 211 are substantially perpendicular to the mounting ends 222 held by second mounting portion 212. It facilitates the assembly of the conductive terminals 220 to the second mating portion 211 and the second mounting portion 212, as well as provides support for different portions of the conductive terminals 220.

The second electrical connector 200 may include a cage 230, as shown in FIGS. 11A and 11B. The cage 230 surrounds outside the main housing 210, and the cage 230 has a front portion 234 extending beyond the second mating portion 211. The longer cage 230 may provide better support for the first electrical connector 100 when mated with the first electrical connector 100. Compared to the main housing 210 or the housing assembly 110 of the mating first electrical connector, the cage 230 may withstand greater external forces, which reduces the risk of breaking the mating portions of the first electrical connector 100 and the second electrical connector 200 by the external forces when the first electrical connector 100 is mated with the second electrical connector 200. The longer cage 230 may provide a space for mounting an outer housing 240. Optionally, the cage 230 may be secured to the first circuit board by adhesives, soldering, snaps, etc., to support and position the main housing 210. The cage 230 may be connected to a signal ground to form an effective shielding against external interference. The second electrical connector 200 may include the outer housing 240 attached to the front portion 234 of the cage 230. The outer housing 240 may include a complementary locking feature, such as a first complementary locking feature 251 and/or a second complementary locking feature 252. The complementary locking feature is configured to receive the locking feature of the mating electrical connector, such as the first locking feature 141 and/or the second locking feature 142. In the embodiment shown in FIG. 14, the outer housing 240 is complex in shape and has different thicknesses at different regions. Thus, the outer housing 240 may be made by a process such as injection molding. Material suitable for the outer housing 240 may include but not limited to liquid crystal polymer (LCP), polyphenylene sulfite (PPS), high-temperature nylon or poly-p-phenylene oxide (PPO), or polypropylene (PP).

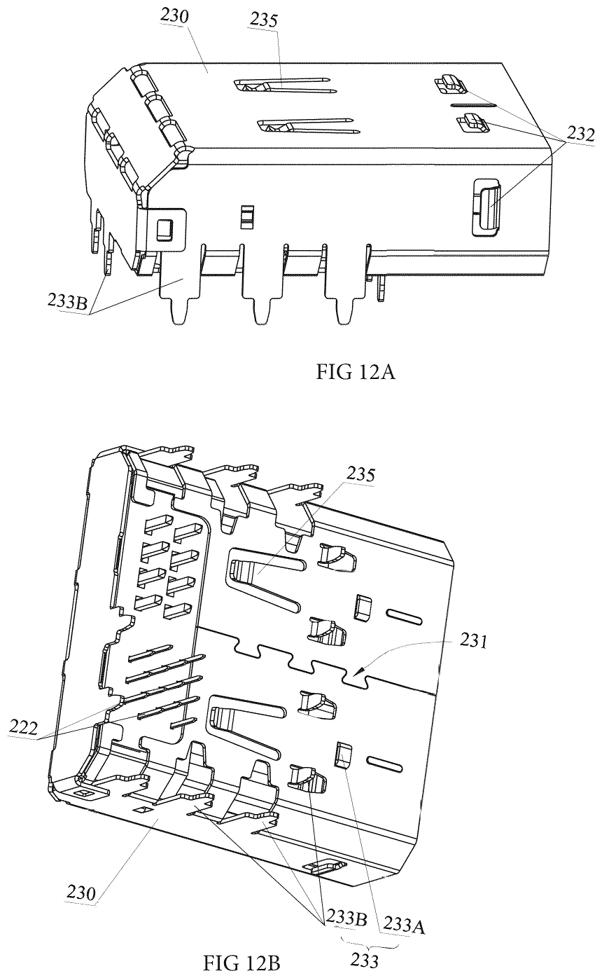

In some embodiments, the cage 230 may be formed by a metal sheet. Opposite edges of the metal sheet are formed with a mortise and tenon for jointing the edges of the metal sheet. As shown in FIG. 12B, the cage 230 substantially wraps up the main housing 210 of the second electrical connector 200, the metal sheet may be stamped into a suitable shape, and the main housing 210 assembled with the conductive terminals 220 is placed into the half-finished stamped cage 230. Subsequently, the main housing 210 is wrapped up by bending the half-finished stamped cage 230. In some embodiments, the mortise and tenon 231 is located on a lower portion of the cage 230. The mortise and tenon 231 can withstand forces parallel to the metal sheet. Compared to soldering the metal sheet to form the cage 230, costs are lower in mass production of the cage 230 by use of the mortise and tenon 231 and stamping process, and the reliability and yield are higher.

In some embodiments, the front portion 234 of the cage 230 may include barbs 232 outwardly protruding, and the outer housing 240 is provided with openings 242 for engaging with the barbs 232. To facilitate the assembly, the barbs 232 may be stamped out of the surface of the cage 230. After the cage 230 is assembled with the main housing 210, the outer housing 240 may be sleeved over the cage 230. At least one of the outer housing 240 and the barbs 232 may be deformable so that the barbs 232 can embedded into the openings 242. After the second electrical connector 200 and the mating electrical connector are connected, the outer housing 240 and the mating electrical connector are interlocked. The outer housing 240 is probably subjected to a pulling force along the mating direction X-X toward the mating electrical connector in use. The barbs 232 of the cage 230 may be hooked to the openings 242 of the outer housing 240 to reduce the risk of the outer housing 240 falling off the cage 230. The positioning in directions perpendicular to the mating direction X-X can be realized by an inner cavity of the outer housing 240 mated with an external profile of the front portion 234 of the cage 230.

In some embodiments, the cage 230 may include a board lock 233, disposed outside the outer housing 240. As described above, the cage 230 may be secured to the first circuit board. Since the second electrical connector 200 may withstand a pulling force after being connected to the mating electrical connector, there are certain requirements for the connection strength between the cage 230, which may be a primary load-bearing component, and the first circuit board, the cage 230 may be connected to the first circuit board by soldering. In some embodiments, one side of the cage 230 may be reliably connected to the first circuit board. In a preferred embodiment, the board lock 233 is protruded from the metal sheet for the cage 230. The board lock 233 may be inserted in a pad via and/or through-hole of the first circuit board, and may also be soldered to the first circuit board such that the cage 230 is firmly secured to the first circuit board. As shown in FIG. 12B, the board lock 233 may include first protrusions 233A and second protrusions 233B. The first protrusions 233A may be inserted in reserved through-holes in the first circuit board, to pre-position the cage 230. The first protrusions 233A may matches the through-holes reserved in the first circuit board so that the cage 230 may not move under slight external forces. This enables the cage 230 to be un-skewed due to swing or slight collision during soldering process. The second protrusions 233B may match with the pad vias of the first circuit board, and the pad vias are usually slightly larger than the second protrusions 233B. The second protrusions 233B are inserted into the pad vias of the first circuit board and fixed reliably to the first circuit board by soldering tin that filling up the gap between the vias and the second protrusions 233B.The cage 230 is locally heated at the soldering parts by use of the board lock 233, such that the difficulty of soldering is reduced. Moreover, when the cage 230 is subjected to external forces, the external forces not only act on the soldering parts, but are also dispersed on the substrate of the first circuit board through the board lock 233 penetrating the first circuit board. The pads at the soldering parts are avoided from separating from the substrate of the first circuit board due to the external forces, so as to enhance the firmness of the second electrical connector 200. Free ends of the second protrusions 233B may have reduced dimensions, such that steps are formed on sides of the second protrusions 233B that are nearly flush with a lower surface of the cage 230. It may allow the reduced ends of the second protrusions 233B to be inserted into the pad vias of the first circuit board, and the steps may abut against the surface of the first circuit board without entering the pad vias. In this way, the cage is positioned and the cage 230 is unlikely to skew.

In some embodiments, an inner surface of the cage 230 and an outer surface of the second mating portion 211 are spaced apart from to form a gap 260 for receiving the first mating portion 110A of the mating electrical connector. In some embodiments, as shown in FIG. 13A, the second mating portion 211 includes a second mating end 211B adapted to the first mating portion 110A, and a second mounting end 211C engaged with the second mounting portion 212. The second mounting end 211C is adapted to the cage 230 in dimensions, and the second mating end 211B is smaller than the second mounting end 211C in dimensions. The cage 230 may be fixed to the second mounting end 211C by structures, such as snaps, while the portion of the cage 230 that accommodates the second mating portion 211B forms the gap 260 with the second mating portion 211B. The gap 260 matches with the first mating portion of the mating electrical connector in dimensions. When the second mating portion 211 is connected to the first mating portion 110A of the mating electrical connector, the first mating portion 110A may be inserted into the cage 230, and the second mating end 211B of the second mating portion 211 is inserted into the opening of the first mating portion 110A. The cage 230 may also be provided with resilient sheets 235, as shown in FIGS. 11A-11B and 12A-12B. After the second electrical connector 200 is mated to the first electrical connector 100, the resilient sheets 235 may press-fit on the outer surface of the first mating portion 110A of the first electrical connector 100, reducing the swing of the first mating portion 110A and/or the second mating portion 211.

In some embodiments, the outer housing 240 may be sleeved over the front portion 234 of the cage 230, and the outer housing 240 includes a locking portion 241 extending beyond the front portion 234. The locking portion 241 may be provided with a complementary locking feature, which may include a first complementary locking feature 251 and/or a second complementary locking feature 252 such as projection, recess and opening. Optionally, the mating electrical connector may include the first locking feature 141, and the first complementary locking feature 251 may be engaged with the first locking feature 141 to lock the mating electrical connector with the outer housing 240, such that the mating electrical connector and the electrical connector 200 do not disconnect accidentally. Optionally, the mating electrical connector may include the second locking feature 142, and the second locking feature 142 may be engaged with the second complementary locking feature 252 to lock the electrical connector 200 with the mating electrical connector. Optionally, the mating electrical connector may include the first locking feature 141 and the second locking feature 142, and the outer housing 240 may include the first complementary locking feature 251 and the second complementary locking feature 252 correspondingly. In some embodiments, when the first locking feature 141 is engaged with the first complementary locking feature 251, the second locking feature 142 is also engaged with the second complementary locking feature 252. In this case, when either of the first locking feature 141 and the second locking feature 142 is unlocked, the mating electrical connectors can still not be moved. For example, if the first locking feature 141 and the second locking feature 142 both are brought to their respective unlocked positions, the mating electrical connectors can be moved. In another embodiment, when the first locking feature 141 is engaged with the first complementary locking feature 251 during the first electrical connector 100 being mated to the second electrical connector 200, the mating electrical connector can be moved along the mating direction for a certain distance, until the second locking feature 142 is engaged with the second complementary locking feature 252. Correspondingly, during the first electrical connector 100 being unmated to the second electrical connector 200, after the second locking feature 142 is disengaged with the second complementary locking feature 252, the mating electrical connector is initially detached from the electrical connector such that the mating electrical connector can be moved for a certain distance. Moreover, the second locking feature 142 remains in the second unlocked position during the partial mating/unmating. The first locking feature 141 can provide the locking between the electrical connector and the mating electrical connector. The mating electrical connector can be completely detached from the electrical connector by simply operating the first locking feature 141 to the first unlocked position. The position of the mating electrical connector partially mated/unmated from the electrical connector can be changed by adjusting the positions of the first complementary locking feature 251 and the second complementary locking feature 252 on the outer housing 240, or the positions of the first locking feature 141 and the second locking feature 142 on the mating electrical connector.

In some embodiments, the outer housing 240 has a first dimension in the first lateral direction Y-Y and a second dimension in the second lateral direction Z-Z. The first dimension is greater than the second dimension. The outer housing 240 has first walls 2401 opposite in the first lateral direction Y-Y and second walls 2402 opposite in the second lateral direction Z-Z, as shown in FIG. 14. One of the second walls 2402 includes a bulge 2402A outwardly protruding. The complementary locking feature includes first openings (e.g., first complementary locking features 251) in the first walls 2401 and a second opening (e.g., second complementary locking feature 252) in the bulge 2402A. Referring back to FIG. 1E, in the illustrated example, the mating electrical connector includes a protrusion in the second lateral direction Z-Z for accommodating a portion of the second locking feature 142. Correspondingly, the outer housing 240 may be provided with the bulge 2402A outwardly protruding from the second wall 2402. The bulge 2402A can accommodate the protrusion of the mating electrical connector inside, which thus may be mated with the second locking feature 142 of the mating electrical connector.

The present disclosure has been described by the above embodiments, but it should be understood that a variety of variations, modifications and improvements may be made according to the teaching of the present disclosure by those skilled in the art, and all of these variations, modifications and improvements fall within the spirit and the scope of protection of the present disclosure. The scope of protection of the present disclosure is defined by the appended claims and its equivalent scope. The above embodiments are only for the purpose of illustration and description, and are not intended to limit the present disclosure to the scope of the described embodiments.

Moreover, although many creative aspects of the electronic system have been described above with reference to a board connector and a cable connector, it should be understood that the aspects of the present disclosure are not limited to these. Any one of the creative features, whether alone or combined with one or more other creative features, can also be used for two mating cable connectors or two mating board connectors. Also, the connector can be used as a plug connector or a socket connector. The connector may be an orthogonal connector, a vertical connector, a coplanar connector, or a right-angle connector.

In the description of the present disclosure, it is to be understood that orientation or positional relationships indicated by orientation words “front”, “rear”, “upper”, “lower”, “left”, “right”, “lateral direction”, “mating direction”, “perpendicular direction”, “perpendicular”, “horizontal”, “top”, “bottom” and the like usually are shown based on the accompanying drawings, only for the purposes of the case in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features”. Thus, the exemplary term “above” can encompass both the orientations of “above” and “below”. In addition, these components or features may be otherwise oriented (for example rotated by 90 degrees or other angles) and the present disclosure is intended to include all these cases.

It should be noted that the terms used herein are only for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

It should be noted that the terms “first”, “second” and the like in the description and claims, as well as the above accompanying drawings, of the present disclosure are used to distinguish similar objects, but not necessarily used to describe a specific order or precedence order. It should be understood that ordinal numbers used in this way can be interchanged as appropriate, so that the embodiments of the present disclosure described herein can be implemented in a sequence other than those illustrated or described herein.

What is claimed is:

1. An electrical connector comprising:
a housing assembly;
a module held by the housing assembly and comprising a plurality of conductive pads along a mating edge disposed in a pitch less than or equal to 1.0 mm and a plurality of conductors extending away from the mating edge; and
a connector position assurance (CPA) device coupled to the housing assembly and configured for securing the electrical connector to a mating electrical connector.

2. The electrical connector of claim 1, wherein:
the plurality of conductive pads are a plurality of first conductive pads configured for signal transmission; and
the module comprises a second conductive pad configured for power transmission.

3. The electrical connector of claim 2, wherein the module comprises:
a circuit board disposed inside the housing assembly and comprising the plurality of first conductive pads and the second conductive pad, each of the plurality of first conductive pads having a front end configured to contact a mating electrical connector and a rear end, the second conductive pad having a front end configured to contact the mating electrical connector and a rear end;
a plurality of first cables comprising first wires disposed in a first pitch less than or equal to 1.0 mm, the first wires having ends mounted to the rear ends of the plurality of first conductive pads of the circuit board so as to electrically connect to the plurality of conductive pads; and
a plurality of second cables comprising second wires disposed in a second pitch greater than the first pitch, the second wires comprising ends mounted to the rear end of the second conductive pad.

4. The electrical connector of claim 1, wherein:
the plurality of conductive pads conform to Peripheral Component Interconnect Express Generation 5 and/or Generation 6 for transmission rates.

5. The electrical connector of claim 1, wherein:
the CPA device comprises a first locking feature having a first locked position and a first unlocked position, and a second locking feature having a second locked position and a second unlocked position;
the first locking feature and the second locking feature are disposed on different sides of the housing assembly; and
the first locking feature is configured to be movable from the first locked position to the first unlocked position when the second locking feature is in the first unlocked position and to remain in the first locked position when the second locking feature is in the second locked position.

6. The electrical connector of claim 5, wherein:
the CPA device comprises a third locking features having a third locked position and a third unlocked position; and
the third locking feature is coupled to the second locking feature such that the second locking feature is in the second locked position when the third locking feature is in the third locked position and the second locking feature is in the second unlocked position when the third locking feature is in the third unlocked position.

7. The electrical connector of claim 5, wherein:
the first locking feature comprises a spring biased element; and
the second locking feature comprises a pull tab.

8. An electrical connector comprising:
a housing assembly;
a module held by the housing assembly and comprising a plurality of conductive pads; and
a connector position assurance (CPA) device coupled to the housing assembly and configured for securing the electrical connector to a mating electrical connector, the CPA device comprising first and second locking features disposed on different sides of the housing assembly.

9. The electrical connector of claim 8, wherein:
the CPA device comprises a first locking feature having a first locked position and a first unlocked position, and a second locking feature having a second locked position and a second unlocked position; and
the first locking feature is configured to be movable from the first locked position to the first unlocked position when the second locking feature is in the first unlocked position and to remain in the first locked position when the second locking feature is in the second locked position.

10. The electrical connector of claim 9, wherein:
the CPA device comprises a third locking features having a third locked position and a third unlocked position; and
the third locking feature is coupled to the second locking feature such that the second locking feature is in the second locked position when the third locking feature is in the third locked position and the second locking feature is in the second unlocked position when the third locking feature is in the third unlocked position.

11. The electrical connector of claim 10, wherein the CPA device comprises:
a first operating member configured to be operable in a mating direction so as to move the first locking feature between the first locked position and the first unlocked position; and
a second operating member configured to be operable in a direction perpendicular to the mating direction so as to move the second locking feature between the second locked position and the second unlocked position.

12. The electrical connector of claim 11, wherein the third locking feature is configured to:
engage the first operating member when the third locking feature is in the third locked position so as to restrain movement of the first operating member, and
disengage the first operating member when the third locked feature is in the third unlocked position.

13. The electrical connector of claim 11, wherein the first locking feature comprises:
a first locking head configured to engage a first side of the mating electrical connector;
a first tail configured to engage the first operating member; and
an intermediate portion joining the first locking head and the first tail and pivotably connected to the housing assembly about a first axis such that the first locking feature is pivotable between the first locked position and the first unlocked position.

14. The electrical connector of claim 13, wherein:
the first locking feature comprises a resilient beam configured to abut the housing assembly so as to bias the first locking head toward outside of the housing assembly; and
the electrical connector comprises a resilient member disposed between the second locking feature and the housing assembly and configured to bias the second locking feature toward the second locked position.

15. The electrical connector of claim 13, wherein:
the second operating member is configured to engage a second side of the mating electrical connector; and
the second operating member comprises the first locking feature, the second locking feature, and an intermediate portion joining the first locking feature and the second locking feature and pivotably connected to the housing assembly about a second axis perpendicular to the first axis.

16. The electrical connector of claim 9, wherein:
the plurality of conductive pads are dimensioned to be in electrical contact with the mating electrical connector as long as the first locking feature is in the first locked position.

17. An electrical connector, comprising:
a main housing comprising a mating portion for engaging a mating electrical connector;
a plurality of conductive terminals held by the main housing;
a cage disposed outside the main housing and comprising a front portion extending beyond the mating portion; and
an outer housing attached to the front portion of the cage, the outer housing comprising first and second locking features configured to engage complementary locking features of the mating electrical connector, the first locking feature disposed on a first side of the outer housing and the second locking feature disposed on a second side of the outer housing.

18. The electrical connector of claim 17, wherein:
the cage comprises a barb protruding outwardly; and
the outer housing comprises an opening for engaging the barb.

19. The electrical connector of claim 17, wherein:
the outer housing comprises a locking portion extending beyond the front portion of the cage, the locking portion comprising the first and second locking features;
the locking portion of the outer housing comprises first walls opposite each other and a second wall joining the first walls, the second wall comprising a bulge protruding outwardly;
the first locking feature comprises first openings extending through the first walls; and
the second locking feature comprises a second opening extending through the bulge.

20. An automotive wiring harness, comprising:
the electrical connector of claim 17,
wherein the main housing comprises a slot configured to receive a substrate comprising a plurality of conductive pads disposed in a pitch less than or equal to 1.0 mm.
